(19) United States
(12) Patent Application Publication
(10) Pub. No.: US 2024/0306050 A1
(43) Pub. Date: Sep. 12, 2024

(54) MANAGING RADIO RESOURCES AND DOWNLINK TRANSMISSION DURING HANDOVER

(71) Applicant: GOOGLE LLC, Mountain View, CA (US)

(72) Inventor: Chih-Hsiang Wu, Taoyuan City (TW)

(21) Appl. No.: 18/281,552

(22) PCT Filed: Mar. 3, 2022
(86) PCT No.: PCT/US22/18618

§ 371 Date: Sep. 11, 2023

Related U.S. Application Data
(60) Provisional application No. 63/159,591, filed on Mar. 11, 2021.

(51) Int. Cl. H04W 36/00; H04W 36/36

(52) U.S. Cl. CPC H04W 36/0072; H04W 36/362

(57) ABSTRACT

A radio access network (RAN) for configuring a user equipment (UE) generates (i) a conditional configuration, and (ii) a condition to be satisfied before the UE applies the conditional configuration (1402), receives, from a core network (CN), an interface message indicating to configure the UE (1404), determines that the interface message affects the conditional configuration (1406), generates a message related to the conditional configuration in view of the received interface message (1408), and transmits the message to the UE (1410).

This disclosure relates generally to wireless communications and, more particularly, to managing radio resources and downlink transmission during handover preparation and execution procedures.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating as the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. MCG DRBs use the lower-layer resources of only the MN, SCG DRBs use the lower-layer resources of only the SN, and split DRBs use the lower-layer resources of both the MCG and the SCG. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

The UE in some scenarios can concurrently utilize resources of multiple RAN nodes (e.g., base stations or components of a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as an MN that covers a primary cell (PCell), and the other base station operates as an SN that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure.

3GPP technical specifications (TS) 36.300 and 38.300 (v16.4.0) describes procedures for handover (or called reconfiguration with sync) scenarios. When these procedures do not involve conditions that are checked at the UE, these procedures can be referred to as immediate or non-conditional handover procedures. When these procedures involve conditions that are checked at the UE, these procedures can be referred to as conditional handover (CHO) procedures.

3GPP TS 37.340 (v16.3.0) describes procedures for a UE to change PSCells in DC scenarios. These procedures involve messaging (e.g., RRC signaling and preparation) between radio access network (RAN) nodes. When these procedures do not involve conditions that are checked at the UE, these procedures can be referred to as immediate or non-conditional PSCell change procedures. When these procedures involve conditions that are checked at the UE, these procedures can be referred to as conditional PSCell change (CPC) procedures.

3GPP specification TS 37.340 v16.4.0 describes procedures for a UE to add or change an SN in DC scenarios. These procedures involve messaging (e.g., RRC signaling and preparation) between RAN nodes. When these procedures do not involve conditions that are checked at the UE, these procedures can be referred to as immediate or non-conditional SN addition/change procedures. When these procedures involve conditions that are checked at the UE, these procedures can be referred to as conditional SN addition/change (CSAC) procedures, also known as conditional PSCell addition/change (CPAC) procedures.

To configure a CHO, CSAC, or CPC procedure, the RAN provides a condition to the UE, along with a configuration (e.g., a set of random-access preambles, etc.) that will enable the UE to communicate with the appropriate base station, or via the appropriate cell, when the condition is satisfied. For example, for CHO, the RAN provides the UE with a condition to be satisfied before the UE can add a candidate base station or a candidate PCell, and a configuration that enables the UE to communicate with that candidate base station or candidate PCell after the condition has been satisfied. As another example, for CSAC or CPC, the RAN provides the UE with a condition to be satisfied before the UE can add a candidate base station as an SN or a candidate PSCell, and a configuration that enables the UE to communicate with that candidate base station or candidate PSCell after the condition has been satisfied. As such, in each of the CHO, CSAC, or CPC procedures, the UE does not immediately apply the conditional configuration upon receiving the conditional configuration; the UE waits until a condition is satisfied to apply the conditional configuration.

Generally speaking, a RAN performs a CHO, CSAC, or CPC “preparation” procedure or the respective immediate (rather than “conditional”) counterpart procedure to generate and provide an immediate or conditional configuration to the UE. In turn, the UE is said to “execute” the immediate or conditional procedure. For example, for an immediate or conditional HO procedure, the RAN performs an immediate or conditional HO preparation procedure by generating an immediate or conditional HO configuration and providing the configuration to the UE. In turn, the UE executes an immediate or conditional HO procedure, such as by immediately disconnecting from a first RAN node and connecting to a second RAN node pursuant to the immediate HO procedure, or delaying the disconnection and connection process until a condition is satisfied pursuant to the CHO procedure.

In some scenarios, while the UE is executing a CHO procedure, the first RAN node receives a request from a core network (CN) for a resource management procedure (e.g., E-RAB Setup procedure, E-RAB Modify procedure, E-RAB Release procedure, PDU Session Resource Setup procedure, PDU Session Resource Modify procedure, PDU Session Resource Release procedure, or downlink NAS transport procedure in accordance with 3GPP specifications 36.413 and 38.413) for the first RAN node to perform with the UE. When the UE disconnects from the first RAN node pursuant to the CHO procedure, the first RAN node fails to communicate with the UE, and thus fails to perform the resource management procedure with the UE.

In other scenarios, the first RAN node receives the request for the resource management procedure from the CN while performing a CHO preparation procedure. When the first RAN node prioritizes the CHO preparation procedure over the request, the first RAN node may determine not to interrupt the CHO preparation procedure, thus failing to perform the resource management procedure pursuant to the request.

### SUMMARY

According to the techniques of this disclosure, a RAN receives a request from a CN to perform a resource management procedure with a UE. In some scenarios, the RAN receives the request when the UE is currently executing a conditional procedure with the RAN according to a conditional configuration received from the RAN. The RAN determines that the UE disconnects with a first RAN node as a result of the UE executing the conditional procedure, and subsequently connects with the UE via a second RAN node, so that the RAN has a radio connection with the UE to perform the resource management procedure in accordance with the request from the CN. In other scenarios, the RAN receives the request from the CN after generating a conditional configuration while performing a conditional preparation procedure for the UE. Because the RAN could not consider the request at the time the RAN generated the conditional configuration, the RAN can send a message to the UE that includes the appropriate parameters pursuant to the request. In yet other scenarios, the RAN receives the request from the CN prior to performing a conditional preparation procedure for the UE. Because the RAN can consider the request at the time the RAN generates the conditional configuration during the conditional preparation procedure, the RAN can send the conditional configuration to the UE.

One example embodiment of these techniques is a method in a RAN for configuring a UE. The method can be executed by processing hardware and includes generating (i) a conditional configuration, and (ii) a condition to be satisfied before the UE applies the conditional configuration, receiving, from a CN, an interface message indicating to configure the UE, determining that the interface message affects the conditional configuration, and generating a message related to the conditional configuration in view of the received interface message, and transmitting the message to the UE. Another embodiment of these techniques is a RAN including processing hardware configured to execute the method above.

Yet another example embodiment of these techniques is a method implemented in a CN for configuring a UE. The method can be executed by processing hardware and includes sending, to a first node of a RAN, a first interface message indicating to configure the UE, receiving, from the RAN, a response interface message indicating failure to configure the UE in view of the first interface message, receiving, from the RAN, a request to switch a path to a second node of the RAN, and sending, to the second node, a second interface message indicating to configure the UE. Still another example embodiment of these techniques is a CN including processing hardware configured to execute the method above.

### BRIEF DESCRIPTION OF THE DRAWINGS

FIG. 1A is a block diagram of an example system in which base station(s) operating in a RAN, CN, and UE can implement the techniques for managing handover procedures;

FIG. 1B is a block diagram of an example base station in which a centralized unit (CU) and a distributed unit (DU) can operate in the system of FIG. 1A;

FIG. 2 is a block diagram of an example protocol stack according to which the UE of FIG. 1A communicates with base station(s);

FIG. 3 is a messaging diagram of an example scenario in which a RAN of FIG. 1A, to recover from sending to a UE a conditional handover configuration that does not include parameters to setup, modify, or release radio resources in accordance with an interface message received from a CN, sends a message to the UE to configure the UE with the parameters to setup, modify, or release radio resources;

FIG. 4A is a messaging diagram of an example scenario in which a base station of FIG. 1A omits sending, to a UE, a conditional handover configuration that does not include parameters to setup, modify, or release radio resources in accordance with an interface message received from a CN;

FIG. 4B is a messaging diagram of an example scenario in which a base station of FIG. 1A sends, to a UE, a conditional handover configuration that includes parameters to setup, modify, or release radio resources in accordance with an interface message received from a CN;

FIG. 5 is a messaging diagram of an example scenario in which a base station of FIG. 1A forwards to a UE a NAS message received from a CN during a conditional handover preparation procedure to setup, modify, or release radio resources;

FIG. 6 is a messaging diagram of an example scenario similar to the scenario of FIG. 3, but where a distributed base station of FIG. 1B sends the message to the UE to configure the UE with the parameters to setup, modify, or release radio resources;

FIG. 7A is a messaging diagram of an example scenario similar to the scenario of FIG. 4A, but where a distributed base station of FIG. 1B omits sending the conditional handover configuration that does not include parameters to setup, modify, or release radio resources;

FIG. 7B is a messaging diagram of an example scenario similar to the scenario of FIG. 4B, but where a distributed base station of FIG. 1B sends the conditional handover configuration that includes parameters to setup, modify, or release radio resources;

FIG. 8 is a messaging diagram of an example scenario similar to the scenario of FIG. 5, but where a distributed base station of FIG. 1B forwards the NAS message to the UE;

FIG. 9 is a flow diagram of an example method for, to recover from sending to a UE a conditional handover configuration that does not include parameters to setup, modify, or release radio resources in accordance with an interface message received from a CN, sending a message to the UE to configure the UE with the parameters to setup, modify, or release radio resources, which can be implemented in a RAN of this disclosure;

FIG. 10 is a flow diagram of an example method similar to the method of FIG. 9, but where the method can be implemented in a distributed base station of this disclosure;

FIG. 11 is a flow diagram of an example method for performing a handover preparation procedure in view of receiving a CN-to-BS interface message to setup, modify, or release radio resources after determining to perform the handover preparation procedure, or while performing the handover preparation procedure, which can be implemented in a RAN of this disclosure;

FIG. 12 is a flow diagram of an example method similar to the method of FIG. 11, but where the CN-to-BS interface message is received before determining to perform the handover preparation procedure, or before performing the handover preparation procedure;

FIG. 13 is a flow diagram of an example method for sending a follow-up message to a RAN to setup, modify, or release radio resources for a UE in response to receiving from the RAN an indication of previously failing to setup, modify, or release the radio resources, which can be implemented in a CN of this disclosure;

FIG. 14 is a flow diagram of an example method for configuring a UE, which can be implemented in a RAN of this disclosure; and

FIG. 15 is a flow diagram of an example method for configuring a UE, which can be implemented in a CN of this disclosure.

### DETAILED DESCRIPTION OF THE DRAWINGS

As discussed in detail below, a RAN generates a conditional configuration for a UE to perform a procedure such as conditional handover (CHO) procedure. When the RAN receives a request from a CN to setup, modify, or release radio resources for the UE before or after sending the conditional configuration to the UE, the RAN can implement the techniques discussed below to configure the UE to setup, modify, or release the radio resource in accordance with the request.

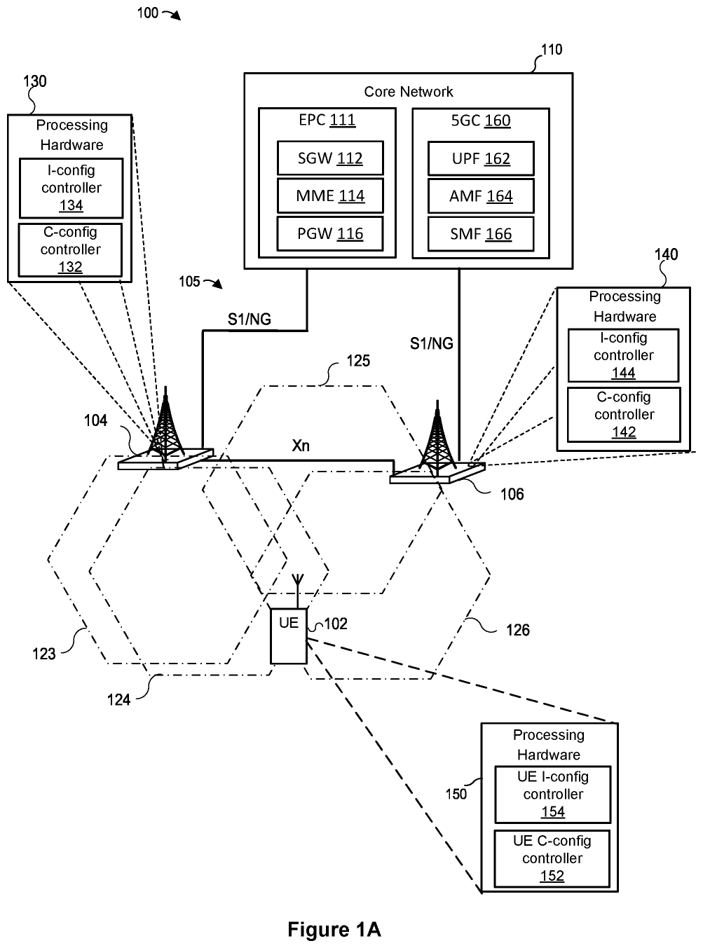

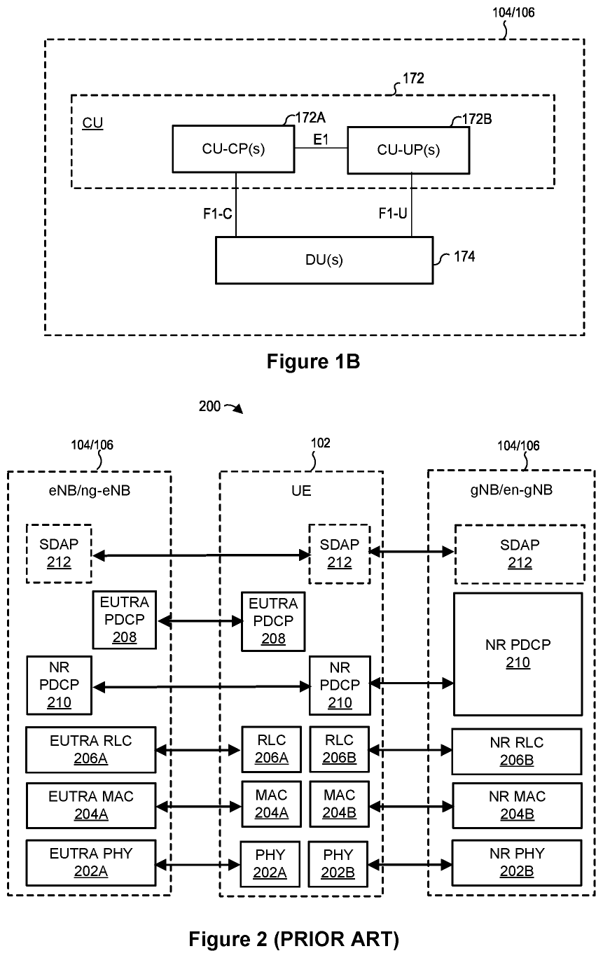

Referring first to FIG. 1A, an example wireless communication system 100 includes a UE 102, a base station (BS) 104, a base station 106, and a core network (CN) 110. The base stations 104 and 106 can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 is generally configured to provide connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106A supports a cell 126. The cells 124 and 126 can partially overlap, so that the UE 102 can hand over from cell 124 to cell 126 or vice versa. The base station 104 can additionally support a cell 123 which can overlap with the cell 124. The base station 106 can additionally support a cell 125 which can overlap with the cell 126. To directly exchange messages during handover preparation scenarios discussed below, the base station 104 and the base station 106 can support an X2 or Xn interface. In general, the CN 110 can connect to any suitable number of base stations supporting NR cells and/or EUTRA cells.

The base station 104 is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration(s) for one or more CHO procedures. The processing hardware 130 also includes an immediate configuration controller 134 configured to manage immediate configuration(s) for one or more immediate procedures (e.g., RRC connection reestablishment, RRC reconfiguration, immediate handover procedures).

The base station 106 is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configuration(s) for one or more CHO procedures. The processing hardware 140 also includes an immediate configuration controller 144 configured to manage immediate configuration(s) for one or more immediate procedures (e.g., RRC connection reestablishment, RRC reconfiguration, measurement configuration, immediate handover procedures).

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration(s) for one or CHO procedures. The processing hardware 150 also includes an immediate configuration controller 154 configured to manage immediate configuration(s) for one or more immediate procedures (e.g., RRC connection reestablishment, RRC reconfiguration, measurement configuration, immediate handover procedures).

More particularly, each of the conditional configuration controllers 132, 142, and 152 can implement at least some of the techniques discussed with reference to the messaging and flow diagrams below to receive a conditional configuration, release the conditional configuration in response to certain events, apply the conditional configuration, etc. For example, when the UE 102 determines that a condition associated with a conditional configuration for CHO is satisfied, the UE 102 can apply the conditional configuration. As used herein, the term “condition” may refer to a single, detectable state or event (e.g., a particular signal quality metric exceeding a threshold), or to a logical combination of such states or events (e.g., Condition A and Condition B, or (Condition A or Condition B) and Condition C, etc.).

In operation, the UE 102 can use a radio bearer (e.g., a DRB or an SRB) that terminates at the base station 104 or base station 106. The UE 102 can apply one or more security keys when communicating on the radio bearer, in the uplink (e.g., from the UE 102 to the base station 104 or 106) and/or downlink (e.g., from the base station 104 or 106 to the UE 102) direction. The UE 102 in some cases can use a RAT to communicate with the base station 104 or 106. Although the examples below may refer specifically to a specific RAT type, 5G NR or EUTRA, in general the techniques of this disclosure also can apply to other suitable radio access and/or core network technologies (e.g., sixth generation (6G)).

In some implementations, the CN 110 communicatively connects the UE 102, to an Internet Protocol (IP) Multimedia Subsystem (IMS) network (not shown in FIG. 1A), via the RAN 105. The IMS network can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network supports packet exchange with the UE. The packets can convey signaling (such as session initiation protocol (SIP) messages, IP messages, or other suitable messages) as well as data (“or media”) such as voice or video. Although the techniques of this disclosure are discussed with specific reference to IMS, the CN 110 in general can connect to, or include, any suitable system that provides packet-based calls.

In some scenarios, the wireless communication system 100 supports immediate handovers between cells. In one scenario, for example, the UE 102 initially connects to the base station 104, and the base station 104 later performs preparation for an immediate handover with the base station 106 via an interface (e.g., X2 or Xn). In this scenario, the base stations 104 and 106 operate as a source base station and a target base station, respectively. In the handover preparation, the source base station 104 sends a Handover Request message to the target base station 106. In response, the target base station 106 includes an immediate handover command message in a Handover Request Acknowledge message, and sends the Handover Request Acknowledge message to the source base station 104. The source base station 104 then transmits a handover command message to the UE 102 in response to receiving the Handover Request Acknowledge message.

Upon receiving the immediate handover command message, the UE 102 immediately reacts to the immediate handover command, by attempting to connect to the target base station 106. To connect to the target base station 106, the UE 102 may perform a random access procedure on a cell (e.g., cell 126) with the target base station 106, and then (after gaining access to a channel) transmit a handover complete message to the target base station 106 via the cell of the base station 106 (i.e., in response to the immediate handover command).

In some implementations, the wireless communication system 100 also supports conditional handovers. In one scenario, for example, the UE 102 initially connects to the base station 104, and the base station 104 later performs a conditional handover preparation procedure with the base station 106 via an interface (e.g., X2 or Xn) to prepare for a potential handover of the UE 102 to the base station 106. In this scenario, the base stations 104 and 106 operate as a source base station and a candidate base station, respectively. In the conditional handover preparation procedure, the source base station 104 sends a Handover Request message to the candidate base station 106. In response, the candidate base station 106 includes a conditional handover command message in a Handover Request Acknowledge message, and sends the Handover Request Acknowledge message to the source base station 104. The source base station 104 then transmits the conditional handover command message to the UE 102, in response to receiving the Handover Request Acknowledge message.

Upon receiving the conditional handover command message, the UE 102 does not immediately react to the message by attempting to connect to the candidate base station 106. Instead, the UE 102 connects to the candidate base station 106 according to the conditional handover command message only if the UE 102 determines that a condition is satisfied for handing over to a candidate cell 126 of the candidate base station 106. The base station 106 provides a configuration for the candidate cell 126 (i.e., a configuration that the UE 102 can use to connect with the base station 106 via the candidate cell 126) in the conditional handover command message.

Before the condition is met, the UE 102 has not yet connected to the candidate base station 106. In other words, the candidate base station 106 has not yet connected and served the UE 102. In some implementations, the condition can be that a signal strength/quality, as measured by the UE 102 on the candidate cell 126 of the candidate base station 106, is “good” enough, and/or a signal strength/quality, as measured by the UE 102 on the cell 124 of the source base station 104, is poor. For example, the condition may be satisfied if one or more measurement results obtained by the UE 102 (when performing measurements on the candidate cell 126) exceed a threshold that is configured by the source base station 104, which could be a pre-determined or pre-configured threshold, and/or if one or more measurement results obtained by the UE 102 (when performing measurements on the candidate cell 126) exceed a threshold that is configured by the source base station 104, which could be a pre-determined or pre-configured threshold. In some implementations, the condition can be that a signal strength/quality, as measured by the UE 102 on the candidate cell 126 is better than a signal strength/quality, as measured by the UE 102 on the cell 124, by at least some threshold value (e.g., at least an offset). The threshold value can be configured by the source base station 104 or a pre-determined or pre-configured offset. If the UE 102 determines that the condition is satisfied, the candidate base station 106 becomes the target base station 106 for the UE 102, and the UE 102 attempts to connect to the target base station 106. To connect to the target base station 106, the UE 102 may perform a random access procedure on the candidate cell 126 with the target base station 106, and then (after gaining access to a channel) transmit a handover complete message via the candidate cell 126 to the target base station 106. After the UE 102 successfully completes the random access procedure and/or transmits the handover complete message, the target base station 106 becomes the source base station 106 for the UE 102, and the UE 102 starts communicating data with the source base station 106.

The base stations 104 and 106 can connect to the same CN 110, which can be an evolved packet core (EPC) 111 or a fifth-generation core (5GC) 160. The base station 104 can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. To directly exchange messages during the scenarios discussed below, the base stations 104 and 106 can support an X2 or Xn interface.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1B depicts an example, distributed or disaggregated implementation of any one or more of the base stations 104, 106. In this implementation, the base station 104 or 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to an Ethernet protocol layer (not shown in FIG. 2), an Internet Protocol (IP) layer (not shown in FIG. 2), Service Data Adaptation Protocol (SDAP) 212 and/or a radio resource control (RRC) sublayer (not shown in FIG. 2). The UE 102, in some implementations, supports both the EUTRA and the NR stack as shown in FIG. 2, to support handover between EUTRA and NR base stations. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

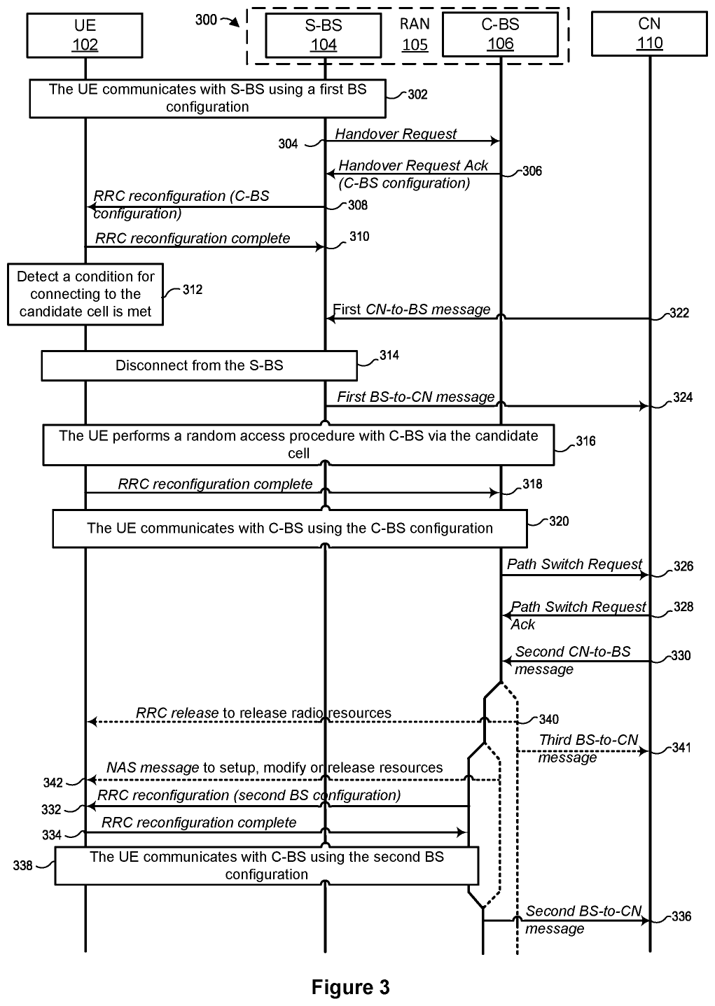

FIGS. 3-5 depict conditional handover scenarios in which a RAN (e.g., RAN 105) prepares a conditional handover for a UE (e.g., UE 102) from a source base station (S-BS) (e.g., S-BS 104) 174A to a candidate base station (C-BS) (e.g., C-BS 106).

Referring first to FIG. 3, the base station 104A in a scenario 300 operates as a source base station (S-BS), and the base station 106A operates as a candidate base station (C-BS).

Initially, the UE 102 communicates 302 data with the S-BS 104 via one or more cells, such as PCells (e.g., cell 124) and zero, one, or more secondary cells (SCells). More particularly, the UE 102 can communicate 302 data and control signals with the S-BS 104 in accordance with a first base station (BS) configuration. The first BS configuration can include one or more configuration parameters that the UE 102 uses to communicate with the S-BS 104. These configuration parameters may configure radio resources for the UE 102 to communicate with the S-BS 104 via the cell(s) described above. The configuration parameters may configure zero, one, or more radio bearers, which may include one or more SRBs (e.g., SRB1 and/or SRB2) and/or one or more DRBs. The data communicated between the UE 102 and the S-BS 104 can include downlink and/or uplink PDUs that the S-BS 104 transmits to the UE 102 and/or receives from the UE 102. The control signals communicated between the UE 102 and the S-BS 104 can include downlink control signals and uplink control signals. The downlink control signals can include channel state information reference signals, tracking reference signals, and/or physical downlink control channel (PDCCH) that the S-BS 104 transmits to the UE 102. The uplink control signals can include hybrid automatic repeat request (HARQ) acknowledgement or negative acknowledgement, channel state information, scheduling request, and/or sounding reference signal that the UE 102 transmits to the S-BS 104.

At a later time, the S-BS 104 initiates a CHO preparation procedure by determining to request, from the C-BS 106, a conditional configuration (i.e., C-BS configuration) to provide to the UE 102 for a CHO procedure so that the UE 102 can communicate with the C-BS 106 via a candidate cell (e.g., cell 126) when a condition is satisfied. The S-BS 104 can make this determination based on one or more measurement results received from the UE 102 directly (e.g., via an SRB established between the UE 102 and the S-BS 104 or via a physical control channel) that are above (or below) one or more predetermined thresholds, or from the S-BS 104 having analyzed measurements on signals, control channels, or data channels received from the UE 102, for example, or another suitable event (e.g., the UE 102 is moving toward the C-BS 106).

In response to this determination, the S-BS 104 transmits 304 a Handover Request message, e.g., including a CHO information request, to the C-BS 106. In response to the Handover Request message, the C-BS 106 generates a C-BS configuration, which includes information that would enable the UE 102 to communicate with the C-BS 106 via a candidate cell (e.g., cell 126). The C-BS 106 includes the C-BS configuration in a Handover Request Acknowledge message for the UE 102, and subsequently transmits 306 the Handover Request Acknowledge message to the S-BS 104 in response to the Handover Request message. In some implementations, instead of including the C-BS configuration in the Handover Request Acknowledge message, the C-BS 106 may include a CHO command in the Handover Request Acknowledge message. In such cases, the C-BS 106 can include the C-BS configuration in the CHO command, and include the CHO command in the Handover Request Acknowledge message. In the following description, the C-BS configuration and CHO command can be interchanged. In some implementations, upon receiving the C-BS configuration, the S-BS 104 includes, in an RRC reconfiguration message, the C-BS configuration and a trigger condition configuration (e.g., triggerCondition-r16 or condExecutionCond-r16 field) specifying a condition (or “triggering condition”) that the UE 102 may use to execute the C-BS configuration or to determine whether to connect to the candidate cell 126. That is, if the UE 102 determines that the condition is satisfied, the UE 102 can use the C-BS configuration to connect to the candidate cell 126. If the UE 102 does not determine that the condition is satisfied, the UE 102 does not connect to the candidate cell 126.

The S-BS 104 transmits 308 the RRC reconfiguration message to the UE 102, which in turn transmits 310 an RRC reconfiguration complete message to the S-BS 104 in response to receiving the RRC reconfiguration message. The events 304, 306, and 308 are collectively referred to in FIG. 3 as a CHO preparation procedure.

In some implementations, the S-BS 104 can include the C-BS configuration in a conditional configuration field or information element (IE) (e.g., CondReconfigToAddMod-r16 IE) of the RRC reconfiguration message. The S-BS 104 can further include a configuration identity/identifier (ID) associated to the C-BS configuration in the conditional configuration field/IE, so that the UE 102 can identify and store the C-BS configuration.

Sometime after the CHO preparation procedure (e.g., after transmitting 310 the RRC reconfiguration complete message), the UE 102 may determine 312 that a condition for connecting to the candidate cell 126 is satisfied, and in response performs 316 a random access procedure (also called a “random access channel” or “RACH” procedure) on the candidate cell 126 with the C-BS 106, e.g., using a random access configuration included in the C-BS configuration. The UE 102 disconnects 314 from the cell 124 of the S-BS 104 in response to events 312 or 316. In some implementations, the random access procedure at event 316 can be a four-step random access procedure or a two-step random access procedure. In other implementations, the random access procedure can be a contention-based random access procedure or a contention-free random access procedure.

The UE 102 sends 318 a RRC reconfiguration complete message to the C-BS 106, via the candidate cell 126, during or after performing 316 the random access procedure. In some implementations, the UE 102 may include the RRC reconfiguration complete message in “message 3” of the four-step random access procedure or in a “message A” of the two-step random access procedure, according to the C-BS configuration.

After performing 316 the random access procedure or transmitting 318 the RRC reconfiguration complete message, the UE 102 communicates 320 with the C-BS 106 by using the C-BS configuration. The events 312, 314, 316, 318, and 320 are collectively referred to in FIG. 3 as a CHO execution procedure.

In some implementations, during the CHO execution procedure, the CN 110 can send 322 a first CN-to-BS interface message to the S-BS 104 for performing a resource management procedure (e.g., E-RAB Setup procedure, E-RAB Modify procedure, E-RAB Release procedure, PDU Session Resource Setup procedure, PDU Session Resource Modify procedure, PDU Session Resource Release procedure, or downlink NAS transport procedure in accordance with 3GPP specifications 36.413 and 38.413) to request to setup, modify, or release resources (e.g., radio resources) for the UE 102 for various reasons. For example, the CN 110 may send the first CN-to-BS interface message for an IMS mobile terminating service (e.g., voice call, video call) for the UE 102. As another example, the CN 110 may send the first CN-to-BS interface message for a multicast or broadcast service (MBS) service for the UE 102. In some implementations, the first CN-to-BS interface message can be a PDU session Resource message, such as a PDU Session Resource Setup Request message, a PDU Session Resource Modify Request message, or a PDU Session Resource Release Command message. In other implementations, the first CN-to-BS interface message can be a E-RAB message, such as a E-RAB Setup Request message, a E-RAB Modify Request message, or a E-RAB Release Command message. In yet other implementations, the first CN-to-BS interface message can be a downlink (DL) NAS Transport message that includes a NAS message. In some implementations, the CN 110 can send the NAS message to setup, modify, or release resources or NAS configurations for the UE 102. In other implementations, the CN 110 can include application data, a short message service (SMS) message, or an LTE positioning protocol (LPP) message in the NAS message.

In response to the first CN-to-BS interface message, if the S-BS 104 transmits to the UE 102 a RRC message (e.g., RRC reconfiguration message) to setup, modify, or release radio resources for the UE 102 when the UE 102 has already disconnected 314 from the S-BS 104 during the CHO execution procedure, the S-BS 104 would fail to transmit the RRC message to the UE 102.

To ensure that the RAN 105 can properly setup, modify, or release radio resources for the UE 102, the S-BS 104 sends 324 a first BS-to-CN interface message to the CN 110. In some implementations, the S-BS 104 includes a cause value in the first BS-to-CN interface message to indicate a reason why the S-BS 104 fails to setup, modify, or release radio resources for the UE 102. For example, the cause value can be “Radio connection with UE lost”. In some implementations, the first BS-to-CN interface message can be a PDU session Resource message, such as a PDU Session Resource Setup Response message, a PDU Session Resource Setup Failure message, a PDU Session Resource Modify Response message, a PDU Session Resource Modify Failure message, or a PDU Session Resource Release Response message. In other implementations, the first BS-to-CN interface message can be a E-RAB message, such as a E-RAB Setup Response message, a E-RAB Modify Response message, or a E-RAB Release Response message. In some implementations, the first BS-to-CN interface message can be an indication that the S-BS 104 failed to send, to the UE 102, the NAS message from the CN 110.

After performing 316 the random access procedure or receiving 318 the RRC reconfiguration complete message, the C-BS 106 can send 326 a Path Switch Request message to the CN 110 to establish a UE associated signaling connection between the UE 102 and the CN 110 and also to request the switch of the downlink termination point of a transport bearer towards the C-BS 106. In response to the Path Switch Request message, the CN 110 performs a path switch for the UE 102 and sends 328 a Path Switch Request Acknowledge message to the C-BS 106. To perform the path switch, the CN 110 can update the S-BS 104-to-UE 102 downlink path to a C-BS 106-to-UE 102 downlink path. Similarly, the CN 110 can update the UE 102-to-S-BS 104 uplink path to a UE 102-to-C-BS 106 uplink path.

After performing the path switch, the CN 110 sends 330 to the C-BS 106 a second CN-to-BS interface message to setup, modify, or release radio resources for the UE 102. In some implementations, the second CN-to-BS interface message is the same as the first CN-to-BS interface message. In other implementations, the second CN-to-BS interface message is similar to the first CN-to-BS interface message with some differences. For example, the CN 110 may include at least one first UE ID in the first CN-to-BS interface message and include at least one second UE ID in the second CN-to-BS interface message. The first UE ID and the second UE ID are associated to the UE 102. The first UE ID is different from the second UE ID. For example, the first UE ID includes a first AMF UE NGAP ID and/or a first RAN UE NGAP ID, and the second UE ID includes a second AMF UE NGAP ID and/or a second RAN UE NGAP ID. The first AMF UE NGAP ID can be the same as or different from the second AMF UE NGAP ID. The first RAN UE NGAP ID can be the same as or different from the second RAN UE NGAP ID. In another example, the first UE ID includes a first MME UE S1AP ID and/or a first eNB UE S1AP ID, and the second UE ID includes a second MME UE S1AP ID and/or a second eNB UE S1AP ID. The first MME UE S1AP ID can be the same as or different from the second MME UE S1AP ID. The first eNB UE S1AP ID can be the same as or different from the second eNB UE S1AP ID.

In some implementations, the CN 110 includes the same PDU Session ID or E-RAB ID in the first CN-to-BS interface message and in the second CN-to-BS interface message. In other implementations, the CN 110 includes in the first and second CN-to-BS interface messages, the same network slice information, e.g., Network Slice Selection Assistance Information (NSSAI) or single NSSAI (S-NSSAI). In yet other implementations, the CN 110 includes the same PDU Session Resource Setup Request Transfer IE in the first and second CN-to-BS interface messages. In yet other implementations, the CN 110 includes a first PDU Session Resource Setup Request Transfer IE in the first CN-to-BS interface message and a second PDU Session Resource Setup Request Transfer IE in the second CN-to-BS interface message. A portion of the first PDU Session Resource Setup Request Transfer IE and a portion of the second PDU Session Resource Setup Request Transfer IE may be the same and the rest of the first and second PDU Session Resource Setup Request Transfer IEs may be different. In some implementations, the CN 110 includes the same Quality of Service (QoS) parameters (values), Transport Layer Address, and/or a tunnel endpoint ID (TEID) in the first and second CN-to-BS interface messages. In other implementations, the CN 110 includes different QoS parameters (values), Transport Layer Addresses, and/or TEIDs in the first and second CN-to-BS interface messages respectively.

In response to receiving the second CN-to-BS interface message, the C-BS 106 can configure to setup, modify, or release radio resources for the UE 102 in accordance with the second CN-to-BS interface message in various manners. In cases of releasing radio resources, the C-BS 106 can release all radio resources configured for the UE 102 (i.e., release a radio connection with the UE 102) or release a portion of radio resources configured for the UE 102. For example, the C-BS 106 can send a RRC release message to the UE 102 to release all radio resources configured for the UE 102. In another example, the C-BS 106 can send a RRC reconfiguration message to release a portion of radio resources configured for the UE 102. In yet another example, the C-BS 106 can send a RRC release message to the UE 102 to release physical radio resources of the radio resources configured for the UE 102 to suspend the radio connection with the UE 102.

In some implementations, if the second CN-to-BS interface message is a DL Transport message that includes a NAS message to setup, modify, or release resources for the UE 102, the C-BS 106 can forward 342 the NAS message to the UE 102. Accordingly, the RAN 105 can properly setup, modify, or release resources for the UE 102 via the C-BS 106.

In other implementations, if the second CN-to-BS interface message is a PDU session Resource message or a E-RAB message that includes an indication or information element to setup, modify, or release radio resources for the UE 102, the C-BS 106 can generate a second BS configuration to setup, modify, or release radio resources for the UE 102. The C-BS 106 can transmit 332 a RRC reconfiguration message including the second BS configuration to the UE 102, and in response to the RRC reconfiguration message, the UE 102 transmits 334 a RRC reconfiguration complete message to the C-BS 106. After receiving 332 the RRC reconfiguration message from the C-BS 106, the UE 102 communicates 338 with the C-BS 106 by using the second BS configuration. The C-BS 106 may not include a random access configuration in the second BS configuration so that the UE 102 does not perform a random access procedure in response to the second BS configuration. Accordingly, the RAN 105 can properly setup, modify, or release radio resources for the UE 102 via the C-BS 106.

In yet other implementations, if the second CN-to-BS interface message is any of a DL NAS Transport message, a PDU session Resource message, or a E-RAB message to release radio resources for the UE 102, the C-BS 106 can send 340 an RRC release message to release radio resources. Accordingly, the RAN 105 can properly release radio resources for the UE 102 via the C-BS 106.

In some implementations, after the C-BS 106 determines to setup, modify, or release radio resources for the UE 102, the C-BS 106 sends 336 a second BS-to-CN interface message to the CN 110 to indicate that the C-BS 106 has successfully setup, modified, or released radio resources for the UE 102 in response to the second CN-to-BS interface message. In other implementations, after or in response to transmitting 342 the NAS message, transmitting 332 the RRC reconfiguration message, or receiving 334 the RRC reconfiguration complete message, the C-BS 106 336 sends the second BS-to-CN interface message to the CN 110. In some implementations, after the C-BS 106 determines to release radio resources for the UE 102 or transmits 340 the RRC release message to release radio resources, the C-BS 106 sends 341 a third BS-to-CN interface message to the CN 110 to indicate that the C-BS 106 has successfully released radio resources for the UE 102 in response to the second CN-to-BS interface message.

The second or third BS-to-CN interface message can be a PDU Session Resource Response message, such as a PDU Session Resource Setup Response message, a PDU Session Resource Modify Response message, or a PDU Session Resource Release Response message. In other implementations, the second or third BS-to-CN interface message can be a E-RAB Setup Response message, a E-RAB Modify Response message, or a E-RAB Release Response message. In some implementations, unlike the first BS-to-CN interface message that may include a cause value to indicate why the S-BS 104 fails to setup, modify, or release radio resources for the UE 102, the second or third BS-to-CN interface message need not include a similar cause value because the C-BS 106 has successfully setup, modified, or released radio resources for the UE 102.

In the implementations of scenario 300 describe above, the C-BS configuration can include multiple configuration parameters for the UE 102 to communicate with the C-BS 106. These configuration parameters may configure radio resources for the UE 102 to communicate with the C-BS 106 via the candidate cell 126 (i.e., candidate primary cell (C-PCell)) and zero, one, or more candidate secondary cells (C-SCells) of the C-BS 106. The multiple configuration parameters may configure zero, one, or more radio bearers, where the radio bearer(s) can include one or more SRBs and/or one or more DRBs. The SRB(s) may include SRB1 and/or SRB2.

In some implementations, the C-BS configuration generated 306 by the C-BS 106 is a complete and self-contained configuration (i.e., a “full” configuration). Within the C-BS configuration, the C-BS 106 may include a full configuration indication (e.g., an IE or field) that indicates that the C-BS configuration is a complete and self-contained configuration. The UE 102 can directly use the C-BS configuration to communicate with the C-BS 106 without referring to the first BS configuration the UE 102 was previously using.

In other implementations, the C-BS configuration can include one or more configurations on top of the first BS configuration (i.e., the C-BS configuration is a “delta” configuration). The UE 102 can use this delta C-BS configuration, together with at least a portion of configuration parameters in the first BS configuration, to communicate with the C-BS 106 at event 320. The delta C-BS configuration is not a complete configuration and does not include a full configuration indication. The UE 102 cannot use only the delta C-BS configuration to communicate with the C-BS 106, and instead also refers to the first BS configuration stored at the UE 102 as shown in event 302. The delta C-BS configuration can include one or multiple configuration parameters for the UE 102 to communicate with the C-BS 106. These configuration parameters may configure radio resources for the UE 102 to communicate with the C-BS 106 via the candidate cell 126 (i.e., C-PCell) and zero, one, or more C-SCells of the C-BS 106. The configuration parameters may configure zero, one, or more radio bearers. The radio bearer(s) can include one or more SRBs and/or one or more DRBs. The configuration parameters may or may not include a measurement configuration and/or a security configuration.

If the C-BS configuration is a full configuration, the C-BS 106 may optionally update the C-BS configuration (i.e., configure new configuration(s), modify existing configuration(s), and/or release existing configuration(s) in the C-BS configuration) in the second BS configuration. If the C-BS configuration is instead a delta configuration, the C-BS 106 can update the C-BS configuration and/or the first BS configuration (i.e., configure new configuration(s), modify existing configuration(s) and/or release existing configuration(s) in the C-BS configuration and/or the first BS configuration) in the second BS configuration.

In response to the second RRC reconfiguration message, the UE 102 updates the first C-BS configuration and/or the first BS configuration using the second BS configuration. Thus, the UE 102 communicates with the C-BS 106 in accordance with the updated first C-BS configuration and/or the updated first BS configuration.

The C-BS configuration can include a group configuration (CellGroupConfig) IE that configures the C-PCell 126 and may configure zero, one, or more C-SCells of the C-BS 106. In some implementations, the C-BS configuration is in an RRCReconfiguration message, RRCReconfiguration-IEs, or a CellGroupConfig IE conforming to 3GPP specification 38.331. In these implementations, the RRC reconfiguration complete messages at event 310 can be an RRCReconfigurationComplete message. In other implementations, the C-BS configuration can include a RadioResourceConfigDedicated IE and/or a MobilityControlInfo IE configuring the C-PCell 126, and may or may not include SCellToAddModList IE configuring one or more C-SCells of the C-BS 106. In other implementations, the C-BS configuration can be an RRCConnectionReconfiguration message or RRCConnectionReconfiguration-IEs conforming to 3GPP specification 36.331. In these implementations, the RRC reconfiguration complete message at event 310 can be an RRCConnectionReconfigurationComplete message.

In some implementations, the first (or second) BS configuration can include a CellGroupConfig IE configuring the PCell 124 (or 126) and zero, one, or more SCells of the S-BS 104 (or the C-BS 106). In some implementations, the first (or second) BS configuration is an RRCReconfiguration message, RRCReconfiguration-IEs, or the CellGroupConfig IE conforming to 3GPP specification 38.331, or includes configurations in the RRCReconfiguration message, RRCReconfiguration-IEs, or CellGroupConfig IE. In other implementations, the first (or second) BS configuration can include a RadioResourceConfigDedicated IE and/or a MobilityControlInfo IE configuring the PCell 124 (or 126), and may or may not include an SCellToAddModList IE configuring one or more SCells of the S-BS 104 (or the C-BS 106). In still other implementations, the first (or second) BS configuration can include configurations in the RadioResourceConfigDedicated IE and/or MobilityControlInfo IE.

If the S-BS 104 is implemented as a gNB, the RRC reconfiguration message of event 308 and the RRC reconfiguration complete message of event 310 can be an RRCReconfiguration message and an RRCConnectionReconfigurationComplete message, respectively. If the S-BS 104 is implemented as an eNB or ng-eNB, the RRC reconfiguration message of event 308 and RRC reconfiguration complete message of event 310 can be implemented as RRCReconfiguration and RRCConnectionReconfigurationComplete messages, respectively.

If the C-BS 106 is implemented as a gNB, the RRC reconfiguration message of event 332 and RRC reconfiguration complete message of event 334 can be an RRCReconfiguration message and an RRCConnectionReconfigurationComplete message, respectively. If the C-BS 106 is implemented as an eNB or a ng-eNB, the RRC reconfiguration message 332 and the RRC reconfiguration complete message 334 can be implemented as RRCReconfiguration and RRCConnectionReconfigurationComplete messages, respectively.

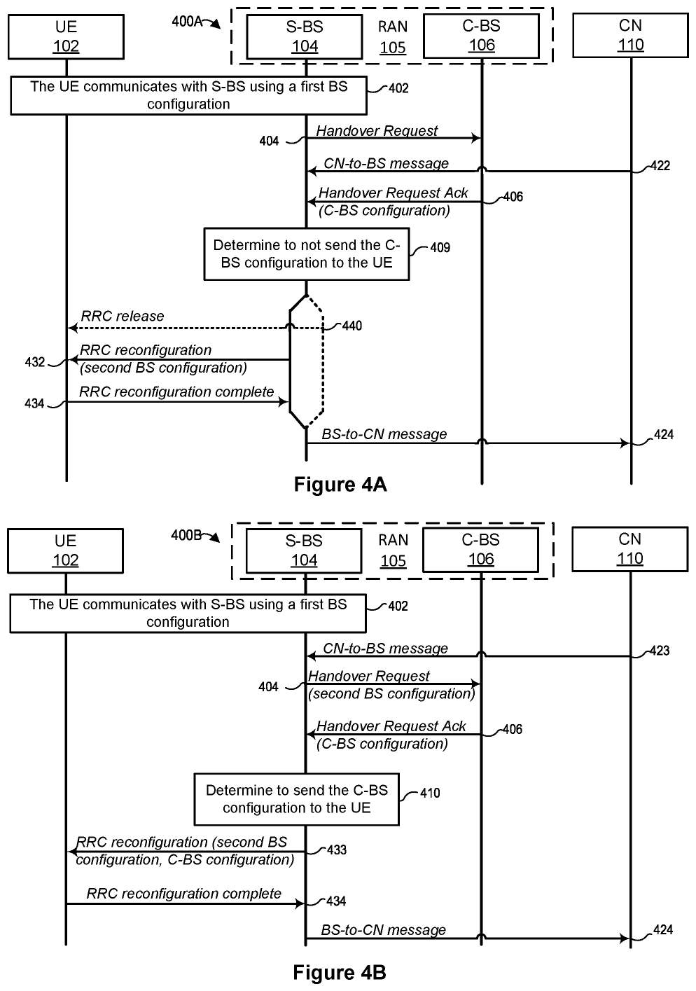

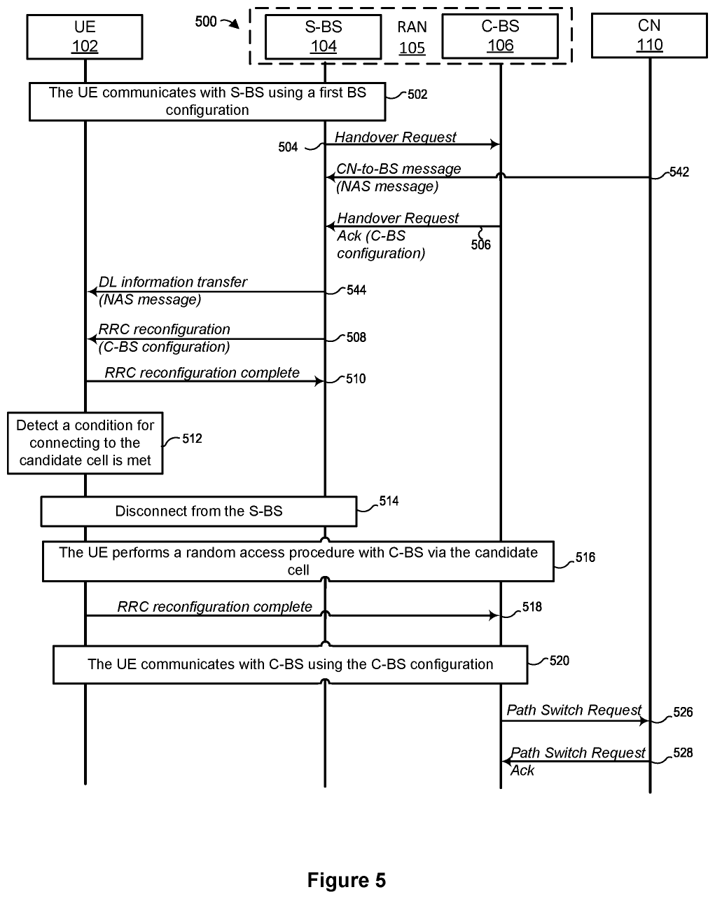

Now referring to FIG. 4A, at the beginning of a scenario 400A, the UE 102 communicates 402 data with the S-BS 104 via one or more cells (e.g., cell 124), similar to event 302. Also similar to events 304 and 306, the S-BS 104 initiates a CHO preparation procedure by transmitting 404 a Handover Request message to the C-BS 106, which in turn transmits 406 a Handover Request Acknowledge message including a C-BS configuration to the UE 102. The C-BS configuration can include information that would enable the UE 102 to communicate with the C-BS 106 via a candidate cell (e.g., cell 126).

Whereas in scenario 300 the CN 110 can send 322 a first CN-to-BS interface message to the S-BS 104 to request to setup, modify, or release radio resources for the UE 102 after the S-BS 104 completes a CHO preparation procedure (e.g., after the S-BS 104 sends 308 the C-BS configuration to the UE 102), in scenario 400A the CN 110 can send 422 a CN-to-BS interface message to the S-BS 104 to request to setup, modify, or release radio resources for the UE 102 during the CHO preparation procedure (e.g., after the C-BS 106 receives 404 the Handover Request message and before the C-BS 106 transmits 406 the Handover Request Acknowledge message). In some implementations, the CN-to-BS interface message can be a PDU session Resource message or a E-RAB message, similar to those described above in FIG. 3. Because the S-BS 104 receives 422 the CN-to-BS interface message after sending 404 the Handover Request message to the C-BS 106, the S-BS 104 is unable to inform the C-BS 106 to change configuration parameters of the C-BS configuration to setup, modify, or release radio resources for the UE 102 in accordance with the CN-to-BS interface message. Thus, the C-BS 106 sends 406 to the S-BS 104 the C-BS configuration that does not contain configuration parameters to setup, modify, or release radio resources in accordance with the CN-to-BS interface message.

As such, the S-BS 104 determines 409 to not send the C-BS configuration to the UE 102. In some implementations, the S-BS 104 may release the C-BS configuration. Instead of sending the C-BS configuration to the UE 102, in response to the determination 409, the S-BS 104 generates a second BS configuration to setup, modify, or release radio resources for the UE 102 if the CN-to-BS interface message indicates to setup, modify, or release radio resources, and transmits 432 to the UE 102 an RRC reconfiguration message including the second BS configuration, in some implementations. In this way, the S-BS 104 ensures that the UE 102 can setup, modify, or release radio resources via the second BS configuration. In response to the RRC reconfiguration message, the UE 102 transmits 434 a RRC reconfiguration complete message to the S-BS 104.

In other implementations, in response to the determination 409, the S-BS 104 may generate an RRC release message for the UE 102 to release radio resources if the CN-to-BS interface message indicates to release radio resources. The S-BS 104 can transmit 440 the RRC release message to the UE 102, to cause the UE 102 to transition to an idle or inactive state.

Accordingly, in the implementations described above, the RAN 105 can properly setup, modify, or release radio resources for the UE 102 via the S-BS 104. In some implementations, after events 432, 434, or 440, the S-BS 104 sends 424 a BS-to-CN interface message to the CN 110 to indicate that the S-BS 104 has successfully setup, modified, or released radio resources for the UE 102 in response to the CN-to-BS interface message, similar to events 336 or 341.

Now referring to FIG. 4B, whereas the S-BS 104 of scenario 400A determines to not send the C-BS configuration to the UE 102, in scenario 400B, the S-BS 104 determines to send the C-BS configuration to the UE 102.

At the beginning of a scenario 400B, similar to scenario 400A, the UE 102 communicates 402 data with the S-BS 104 via one or more cells (e.g., cell 124) and the S-BS 104 initiate a CHO preparation procedure with the C-BS 106A in events 404 and 406. However, in contrast to scenario 400A in which the CN 110 sends 422 a CN-to-BS interface message to the S-BS 104 to request to setup, modify, or release radio resources for the UE 102 during the CHO preparation procedure, the CN 110 in scenario 400B sends 423 the CN-to-BS interface message to the S-BS 104 to request to setup, modify, or release radio resources for the UE 102 before the S-BS 104 initiates the CHO preparation procedure. As such, the S-BS 104 can generate the second BS configuration described above in FIG. 4A and include the second BS configuration in the Handover Request message in event 404. In addition, the S-BS 104 determines configuration parameters in a format of an interface protocol (e.g., X2 or Xn application protocol) after the S-BS 104 has taken into account the CN-to-BS message that requests to setup, modify, or release radio resources. Then, the S-BS 104 includes UE capabilities and the configuration parameters in the Handover Request message.

Consequently, because the C-BS 106 receives the second BS configuration (and thus is aware of the configuration parameters to setup, modify, or release radio resources according to the CN-to-BS interface message), the C-BS 106 can generate the C-BS configuration on top of the second BS configuration (i.e., the C-BS configuration is a “delta” configuration). Alternatively, the S-BS 104 does not include the second BS configuration in the Handover Request message. In this alternative implementation, the C-BS 106 can generate a full C-BS configuration (i.e., the C-BS configuration is a “full” configuration) in accordance with the UE capabilities and the configuration parameters. In turn, the C-BS 106 can include the C-BS configuration in the Handover Request Acknowledge message, and subsequently transmits 406 the Handover Request Acknowledge message to the S-BS 104.

In turn, the S-BS 104 can determine 410 to send the C-BS configuration to the UE 102, and consequently transmits 433 to the UE 102 an RRC reconfiguration message including the C-BS configuration and the second BS configuration. The S-BS 104 can include a trigger condition configuration in the RRC reconfiguration message, similar to event 308. As a result, the UE 102 can setup, modify, or release radio resources according to at least a portion of configuration parameters in the second BS configuration, as well as execute a CHO procedure when a condition is satisfied pursuant to the C-BS configuration, to communicate with the C-BS 106 at event 320. In this way, the S-BS 104 ensures that the UE 102 can setup, modify, or release radio resources via the second BS configuration. In response to the RRC reconfiguration message, the UE 102 transmits 434 a RRC reconfiguration complete message to the S-BS 104.

Accordingly, in the implementations described above, the RAN 105 can properly setup, modify, or release radio resources for the UE 102 via the S-BS 104. In some implementations, after events 433 or 434, the S-BS 104 sends 424 a BS-to-CN interface message to the CN 110 to indicate that the S-BS 104 has successfully setup, modified, or released radio resources for the UE 102 in response to the CN-to-BS interface message, similar to events 336 or 341.

Now referring to FIG. 5, at the beginning of a scenario 500, the UE 102 communicates 302 data with the S-BS 104 via one or more cells (e.g., cell 124), similar to event 302. Also similar to events 304 and 306, the S-BS 104 initiate a CHO preparation procedure by transmitting 504 a Handover Request message to the C-BS 106, which in turn transmits 506 a Handover Request Acknowledge message including a C-BS configuration to the UE 102. The C-BS configuration can include information that would enable the UE 102 to communicate with the C-BS 106 via a candidate cell (e.g., cell 126).

Whereas in scenario 300 the CN 110 can send 322 a first CN-to-BS interface message to the S-BS 104 to request to setup, modify, or release radio resources for the UE 102 after the S-BS 104 completes a CHO preparation procedure (e.g., after the S-BS 104 sends 308 the C-BS configuration to the UE 102), in scenario 500 the CN 110 can send 542 a CN-to-BS interface message including a NAS message to the S-BS 104 to request to setup, modify, or release resources for the UE 102 during the CHO preparation procedure (e.g., after the C-BS 106 receives 504 the Handover Request message and before the C-BS 106 transmits 506 the Handover Request Acknowledge message), for reasons similar to those discussed in FIG. 3. In some implementations, the first CN-to-BS interface message can be a downlink (DL) NAS Transport message.

In response to receiving 542 the CN-to-BS interface message, the S-BS 104 transmits 544 an RRC message that includes the NAS message to the UE 102. In some implementations, the RRC message is a DL Information Transfer message. Subsequent to transmitting 544 the RRC message to the UE 102, the S-BS 104 transmits 508 an RRC reconfiguration message including the C-BS configuration to the UE 102, which in turn transmits 510 an RRC reconfiguration complete message to the S-BS 104 in response to receiving the RRC reconfiguration message, similar to events 308 and 310, respectively. Alternatively, the S-BS 104 can transmit 544 the RRC message to the UE 102 after transmitting 508 the RRC reconfiguration message.

Sometime after transmitting the RRC reconfiguration complete message, the UE 102 may determine 512 that a condition for connecting to the candidate cell 126 is satisfied, and in response performs 516 a random access procedure on the candidate cell 126 with the C-BS 106, similar to events 312 and 316. The UE 102 disconnects 514 from the cell 124 of the S-BS 104 in response to events 512 or 516, similar to event 314. Because the S-BS 104 already transmitted the NAS message to the UE 102 prior to the UE 102 disconnecting 514 from the cell 124 of the S-BS 104, the S-BS 104 ensures that the UE 102 receives instructions in time from the CN 110 to setup, modify, or release resources or NAS configurations via the NAS message.

During or after performing 516 the random access procedure, the UE 102 sends 518 a RRC reconfiguration complete message to the C-BS 106, via the candidate cell 126, similar to event 318. After performing 516 the random access procedure or transmitting 518 the RRC reconfiguration complete message, the UE 102 communicates 520 with the C-BS 106 by using the C-BS configuration, similar to 520. After performing 516 the random access procedure or receiving 518 the RRC reconfiguration complete message, the C-BS 106 can send 526 a Path Switch Request message to the CN 110 to establish a UE associated signaling connection to the CN 110 and also to request the switch of the downlink termination point of a transport bearer towards the C-BS 106, similar to event 326. In response to the Path Switch Request message, the CN 110 performs a path switch for the UE 102 and sends 528 a Path Switch Request Acknowledge message to the C-BS 106, similar to event 328.

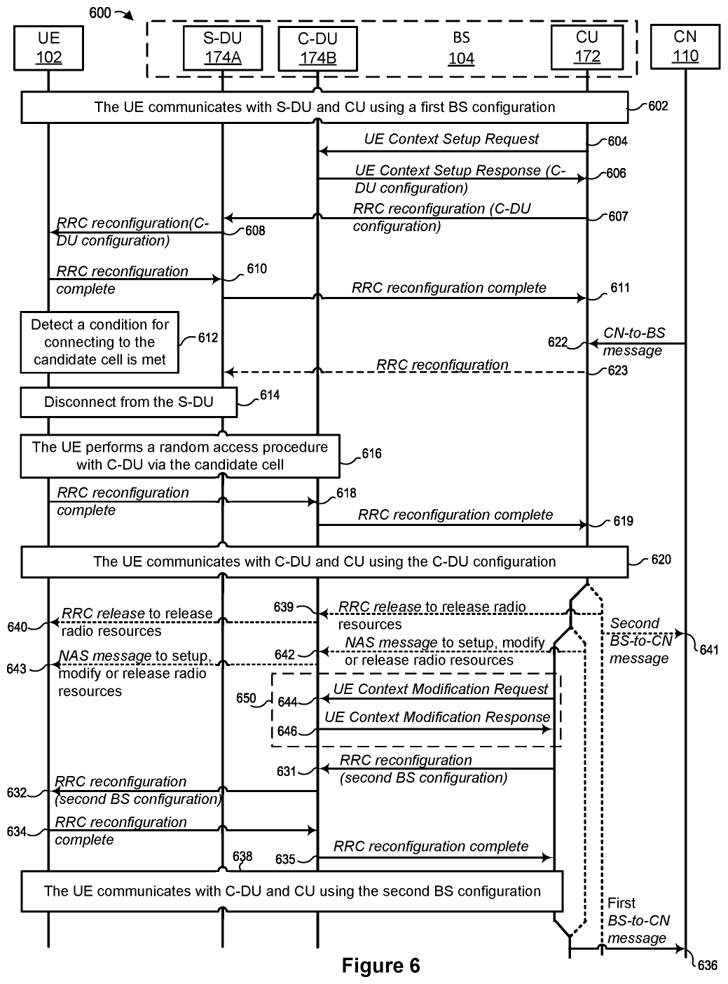

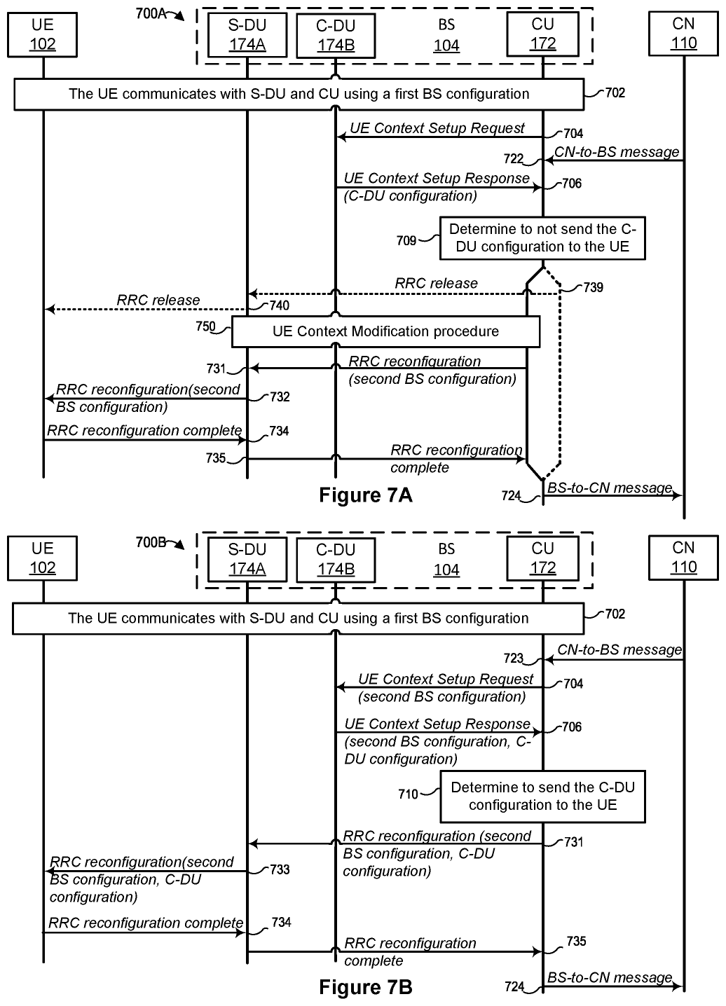

FIGS. 6-8 depict additional conditional handover scenarios. Unlike FIGS. 3-5, FIGS. 6-8 depict scenarios in which a distributed base station 104 with a CU 172 and at least two DUs 174 prepares a conditional handover from a source DU (S-DU) 174A to a candidate DU (C-DU) 174B.

Referring first to FIG. 6, in a scenario 600, the UE 102 communicates 602 data with S-DU 174A via one or more cells (e.g., cell 124) and CU 172 in accordance with a first BS configuration, similar to event 302.

At a later time, the CU 172 initiates a CHO preparation procedure by determining to configure the UE 102 with a conditional configuration (i.e., C-DU configuration) for a CHO procedure so that the UE 102 can communicate with the C-DU 174B via a candidate cell (e.g., cell 126) when a condition is satisfied. The CU 172 can make this determination based on one or more measurement results received from the UE 102 directly (e.g., via an SRB established between the UE 102 and the S-DU 174A or via a physical control channel) that are above (or below) one or more predetermined thresholds, or from the CU 172 having analyzed measurements on signals, control channels, or data channels received from the UE 102, for example, or another suitable event (e.g., the UE 102 is moving toward the C-DU 174B).

In response to this determination, the CU 172 transmits 604 a UE Context Setup Request message to the C-DU 174B. In response to the UE Context Setup Request message, the C-DU 174B generates a C-DU configuration for a candidate cell associated with the C-DU 174B (e.g., cell 126). The C-DU 174B includes the C-DU configuration in a UE Context Setup Response message for the UE 102, and subsequently transmits 606 the UE Context Setup Response message to the CU 172 in response to the UE Context Setup Request message. The C-DU configuration includes information that would enable the UE 102 to communicate with the C-DU 174B via a candidate cell (e.g., cell 126). The C-DU configuration may be a “full” configuration or a “delta” configuration, as discussed above with reference to FIG. 3, and the configuration parameters may be similar to those discussed above with reference to FIG. 3.

The CU 172 transmits 607 an RRC reconfiguration message including the C-DU configuration and a trigger condition configuration to the S-DU 174A, similar to event 308. The S-DU 174A then sends 608 the RRC reconfiguration message that includes the C-DU configuration to the UE 102. The UE 102 responds by transmitting 610 an RRC reconfiguration complete message to the S-DU 174A, and in response the S-DU 174A sends 611 an RRC reconfiguration complete message to the CU 172. The events 604, 606, 607 and 608 are collectively referred to in FIG. 6 as a CHO preparation procedure.

Sometime after the CHO preparation procedure (e.g., after transmitting 610 the RRC reconfiguration complete message), the UE 102 may determine 612 that a condition for connecting to the candidate cell 126 is satisfied, and in response performs 616 a random access procedure on the candidate cell 126 with the C-DU 174B, similar to events 312 and 316, respectively. The UE 102 disconnect 314 from the S-DU 174A in response to events 312 or 316.

Similar to event 318, the UE 102 sends 618 a RRC reconfiguration complete message to the C-DU 174B, via the candidate cell 126, during or after performing 616 the random access procedure. In turn, the C-DU 174B transmits 619 the RRC reconfiguration complete message to the CU 172.

After performing 616 the random access procedure or transmitting 618 the RRC reconfiguration complete message, the UE 102 communicates 620 with the C-DU 174B and the CU 172 by using the C-DU configuration. The events 612, 614, 616, 618, 619, and 620 are collectively referred to in FIG. 6 as a CHO execution procedure.

In some implementations, during the CHO execution procedure, the CN 110 can send 622 a CN-to-BS interface message to the CU 172 to request to setup, modify, or release radio resources for the UE 102 for various reasons, similar to event 322.

In response to the CN-to-BS interface message, the CU 172 may optionally generate and transmit 623, to the S-DU 174A, a first RRC message (e.g., RRC reconfiguration message) to setup, modify, or release radio resources for the UE 102. In turn, the S-DU 174A may attempt to transmit the first RRC message to the UE 102. However, if the UE 102 has already disconnected 614 from the S-DU 174A during the CHO execution procedure prior to when the S-DU 174A transmits the first RRC message, the CU 172 would fail to transmit the first RRC message to the UE 102.

To ensure that the BS 104 can properly setup, modify, or release radio resources for the UE 102, the CU 172 can configure to setup, modify, or release radio resources for the UE 102 in accordance with the CN-to-BS interface message in various manners as described for the C-BS 106 in FIG. 3.

In some implementations, if the CN-to-BS interface message is a DL NAS Transport message that includes a NAS message to setup, modify, or release resources for the UE 102, the CU 172 can forward 642 the NAS message to the UE 102, similar to event 342, by transmitting 642 the NAS message to the C-DU 174B, which in turn forwards 643 the NAS message to the UE 102. Accordingly, the CU 172 can properly setup, modify, or release resources (e.g., radio resources) for the UE 102 via the C-DU 174B.

In other implementations, if the CN-to-BS interface message is a PDU session Resource message or a E-RAB message that includes an indication or information element to setup, modify, or release radio resources for the UE 102, the CU 172 sends 644 a UE Context Modification Request message to the C-DU 174B. In response, the C-DU 174B generates a second BS configuration to setup, modify, or release radio resources for the UE 102 in accordance with the CN-to-BS interface message at event 622. The C-DU 174B can send 646 a UE Context Modification Response message including a DU configuration to the CU 172, which then generates a second BS configuration including the DU configuration. The CU 172 can generate other configuration parameters and include these configuration parameters in the second BS configuration. The events 644 and 646 are collectively referred to in FIG. 6 as a UE Context Modification procedure 650. In turn, the CU 172 sends 631, to the C-DU 174B, a second RRC message (e.g., RRC reconfiguration message) including the second BS configuration to setup, modify, or release radio resources for the UE 102 after the UE 102 completes the CHO execution procedure, e.g., after event 620. In response, the C-DU 174B transmits 632 the second RRC message including the second BS configuration to the UE 102. The UE 102 responds by transmitting 634 a RRC reconfiguration complete message to the C-DU 174B, which in turn forwards 635 the RRC reconfiguration complete message to the CU 172. After receiving 632 the second RRC message, the UE 102 communicates 638 with the C-DU 174B and the CU 172 by using the second BS configuration. Accordingly, the CU 172 can properly setup, modify, or release radio resources for the UE 102 via the C-DU 174B.

In yet other implementations, if the second CN-to-BS interface message is any of a DL NAS Transport message, a PDU session Resource message, or a E-RAB message to release resources for the UE 102, the CU 172 can send 640 a RRC release message to the UE 102 to release radio resources, similar to event 340, by transmitting 639 the RRC release message to the C-DU 174B, which in turn forwards 640 the RRC release message to the UE 102. Accordingly, the CU 172 can properly release radio resources for the UE 102 via the C-DU 174B. In some implementations, the CU 172 can send a UE Context Release Command message to the C-DU 174B to release radio resources for the UE 102 at event 639. The CU 172 can include the RRC release message in the UE Context Release Command message. In response to the UE Context Release Command message, the C-DU 174B release radio resources for the UE 102.

In some implementations, after the CU 172 determines to setup, modify, or release radio resources for the UE 102, the CU 172 sends 636 a first BS-to-CN interface message to the CN 110 to indicate that the CU 172 has successfully setup, modified, or released radio resources for the UE 102 in response to the CN-to-BS interface message, similar to event 336. In other implementations, after or in response to transmitting 642 the NAS message, transmitting 631 the RRC reconfiguration message, or receiving 635 the RRC reconfiguration complete message, the CU 172 sends 636 the first BS-to-CN interface message to the CN 110. In some implementations, after the CU 172 determines to release radio resources for the UE 102 or transmits 639 the RRC release message to release radio resources, the CU 172 sends 641 a second BS-to-CN interface message to the CN 110 to indicate that the CU 172 has successfully released radio resources for the UE 102 in response to the CN-to-BS interface message, similar to event 341.

Now referring to FIG. 7A, at the beginning of a scenario 700A, the UE 102 communicates 702 data with the S-DU 174A via one or more cells (e.g., cell 124) and the CU 172, similar to event 602. Also similar to events 604 and 606, the CU 172 initiates a CHO preparation procedure by transmitting 704 a UE Context Setup Request message to the C-DU 174B, which in turn transmits 706 a UE Context Setup Response message including a C-DU configuration to the UE 102. The C-DU configuration can include information that would enable the UE 102 to communicate with the C-DU 174B via a candidate cell (e.g., cell 126).

Whereas in scenario 600 the CN 110 can send 622 a CN-to-BS interface message to the CU 172 to request to setup, modify, or release radio resources for the UE 102 after the CU 172 completes a CHO preparation procedure (e.g., after the S-DU 174A sends 608 the C-BU configuration to the UE 102), in scenario 700A the CN 110 can send 722 a CN-to-BS interface message to the CU 172 to request to setup, modify, or release radio resources for the UE 102 during the CHO preparation procedure (e.g., after the C-DU 174B receives 704 the UE Context Setup Request message and before the C-DU 174B transmits 706 the UE Context Setup Response message). In some implementations, the CN-to-BS interface message can be a PDU session Resource message or a E-RAB message, similar to those described above in FIG. 3. Because the CU 172 receives 722 the CN-to-BS interface message after sending 704 the UE Context Setup Request message to the C-DU 174B, the CU 172 is unable to inform the C-DU 174B to change configuration parameters of the C-DU configuration to setup, modify, or release radio resources for the UE 102 in accordance with the CN-to-BS interface message. Thus, the C-DU 174B sends 706 to the CU 172 the C-DU configuration that does not contain configuration parameters to setup, modify, or release radio resources in accordance with the CN-to-BS interface message.

As such, the CU 172 determines 709 to not send the C-DU configuration to the UE 102. Instead of sending the C-DU configuration to the UE 102, in response to the determination 709, the CU 172 performs a UE Context Modification procedure 750 with the S-DU 174A, similar to the manner in which the CU 172 performs the UE Context Modification procedure 650 with the C-DU 174B. Accordingly, the CU 172 receives from the S-DU 174A a second BS configuration to setup, modify, or release radio resources for the UE 102 if the CN-to-BS interface message indicates to setup, modify, or release radio resources. The CU 172 transmits 731 to the S-DU 174A an RRC reconfiguration message including the second BS configuration, which in turn forwards 732 the RRC reconfiguration message to the UE 102, in some implementations. In this way, the CU 172 ensures that the UE 102 can setup, modify, or release radio resources via the second BS configuration. In response to the RRC reconfiguration message, the UE 102 transmits 734 a RRC reconfiguration complete message to the S-DU 174A, which in turn forwards 735 the RRC reconfiguration complete message to the CU 172.

In other implementations, in response to the determination 709, the CU 172 may generate an RRC release message for the UE 102 to release radio resources if the CN-to-BS interface message indicates to release radio resources. The CU 172 can transmit 739 the RRC release message to the S-DU 174A, which in turn forwards 740 the RRC release message to the UE 102, to cause the UE 102 to transition to an idle or inactive state.

Accordingly, in the implementations described above, the BS 104 can properly setup, modify, or release radio resources for the UE 102 via the CU 172. In some implementations, after events 732, 734, or 740, the CU 172 sends 724 a BS-to-CN interface message to the CN 110 to indicate that the CU 172 has successfully setup, modified, or released radio resources for the UE 102 in response to the CN-to-BS interface message, similar to events 636 or 641.

Now referring to FIG. 7B, whereas the CU 172 of scenario 700A determines to not send the C-DU configuration to the UE 102, in scenario 700B, the CU 172 determines to send the C-DU configuration to the UE 102.

At the beginning of a scenario 700B, similar to scenario 700A, the UE 102 communicates 702 data with the S-DU 174A via one or more cells (e.g., cell 124) and the CU 172, and the CU 172 initiate a CHO preparation procedure with the C-DU 174BA in events 704 and 706. However, in contrast to scenario 700A in which the CN 110 sends 722 a CN-to-BS interface message to the CU 172 to request to setup, modify, or release radio resources for the UE 102 during the CHO preparation procedure, the CN 110 in scenario 700B sends 723 the CN-to-BS interface message to the CU 172 to request to setup, modify, or release radio resources for the UE 102 before the CU 172 initiates the CHO preparation procedure. As such, the CU 172 can generate the second BS configuration described above in FIG. 7A and include the second BS configuration in the UE Context Setup Request message in event 704. In addition, the CU 172 determines configuration parameters in a format of an interface protocol (e.g., F1 or W1 application protocol) after the CU 172 has taken into account the CN-to-BS message that requests to setup, modify, or release radio resources. Then, the CU 172 includes UE capabilities and the configuration parameters in the UE Context Setup Request message.

Consequently, because the C-DU 174B receives the second BS configuration (and thus is aware of the configuration parameters to setup, modify, or release radio resources according to the CN-to-BS interface message), the C-DU 174B can generate the C-DU configuration on top of the second BS configuration. Alternatively, the CU 172 does not include the second BS configuration in the UE Context Setup Request message. In this alternative implementation, the C-BS 106 can generate a full C-BS configuration (i.e., the C-BS configuration is a “full” configuration) in accordance with the UE capabilities and the configuration parameters. In turn, the C-DU 174B can include the C-DU configuration in the UE Context Setup Response message, and subsequently transmits 706 the UE Context Setup Response message to the CU 172.

In turn, the CU 172 can determine 710 to send the C-DU configuration to the UE 102, and consequently transmits 731 to the S-DU 174A an RRC reconfiguration message including the C-DU configuration on top of the second BS configuration, which in turn forwards 733 the RRC reconfiguration message to the UE 102. The CU 172 can include a trigger condition configuration in the RRC reconfiguration message, similar to event 308. In this way, the CU 172 ensures that the UE 102 can setup, modify, or release radio resources via the second BS configuration. In response to the RRC reconfiguration message, the UE 102 transmits 734 a RRC reconfiguration complete message to the S-DU 174A, which in turn forwards 735 the RRC reconfiguration complete message to the CU 172.

Accordingly, in the implementations described above, the BS 104 can properly setup, modify, or release radio resources for the UE 102 via the CU 172. In some implementations, after events 731 or 735, the CU 172 sends 724 a BS-to-CN interface message to the CN 110 to indicate that the CU 172 has successfully setup, modified, or released radio resources for the UE 102 in response to the CN-to-BS interface message, similar to events 636 or 641.

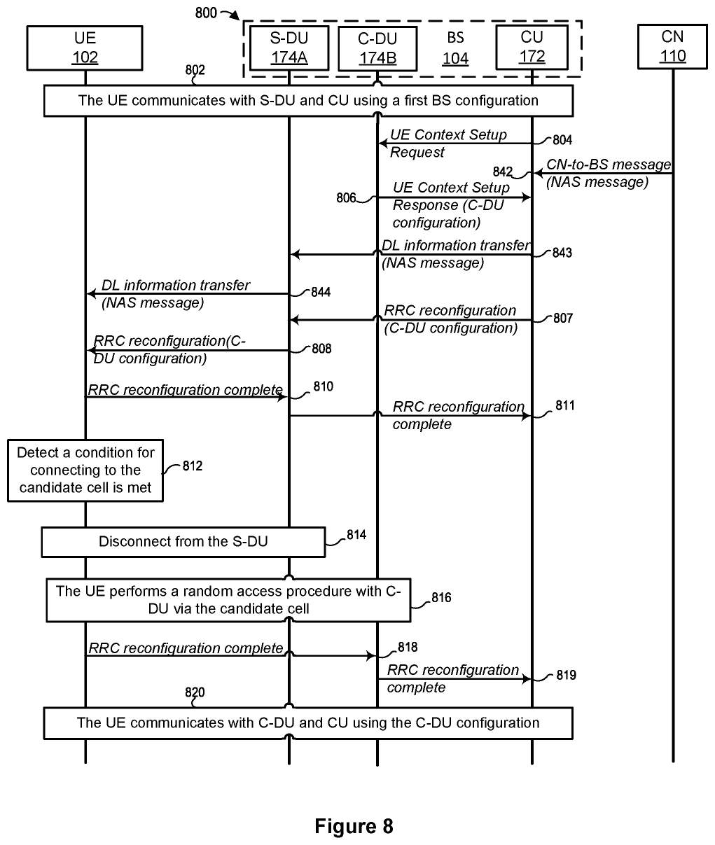

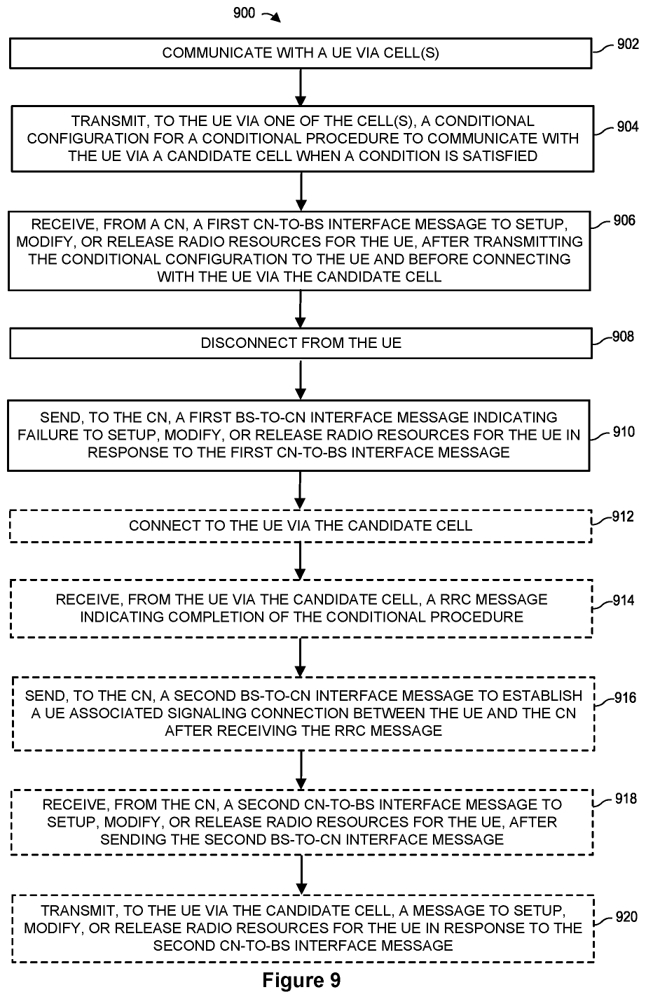

Now referring to FIG. 8, at the beginning of a scenario 800, the UE 102 communicates 802 data with the S-DU 174A via one or more cells (e.g., cell 124) and the CU 172, similar to event 602. Also similar to events 604 and 606, the CU 172 initiate a CHO preparation procedure by transmitting 804 a UE Context Setup Request message to the C-DU 174B, which in turn transmits 806 a UE Context Setup Response message including a C-DU configuration to the UE 102. The C-DU configuration can include information that would enable the UE 102 to communicate with the C-DU 174B via a candidate cell (e.g., cell 126).

Whereas in scenario 600 the CN 110 can send 622 a CN-to-BS interface message to the CU 172 to request to setup, modify, or release radio resources for the UE 102 after the CU 172 completes a CHO preparation procedure (e.g., after the S-DU 174A sends 608 the C-BU configuration to the UE 102), in scenario 800 the CN 110 can send 842 a CN-to-BS interface message including a NAS message to the CU 172 to request to setup, modify, or release resources for the UE 102 during the CHO preparation procedure (e.g., after the C-DU 174B receives 704 the UE Context Setup Request message and before the C-DU 174B transmits 706 the UE Context Setup Response message). In some implementations, the CN-to-BS interface message can be a downlink (DL) NAS Transport message.

In response to receiving 842 the CN-to-BS interface message, the CU 172 transmits 843 an RRC message that includes the NAS message to the S-DU 174A, which in turn forwards 844 the RRC message to the UE 102. In some implementations, the RRC message is a DL Information Transfer message. Subsequent to transmitting the RRC message to the UE 102, the CU 172 transmits 807 an RRC reconfiguration message including the C-DU configuration to the S-DU 174A, which in turn forwards 808 the RRC reconfiguration message to the UE 102. In response, the UE 102 transmits 810 an RRC reconfiguration complete message to the S-DU 174A, which in turn forwards 811 the RRC reconfiguration complete message to the CU 172. Alternatively, the CU 172 can transmit 843 the RRC message to the S-DU 174A after transmitting 807 the RRC reconfiguration message. Thus, the S-DU 174A can transmit 844 the RRC message after transmitting 808 the RRC reconfiguration message.

Sometime after transmitting the RRC reconfiguration complete message, the UE 102 may determine 812 that a condition for connecting to the candidate cell 126 is satisfied, and in response performs 816 a random access procedure on the candidate cell 126 with the C-DU 174B, similar to events 612 and 616. The UE 102 disconnects 814 from the cell 124 of the S-DU 174A in response to events 812 or 816, similar to event 614. Because the CU 172 already transmitted the NAS message to the UE 102 prior to the UE 102 disconnecting 814 from the cell 124 of the S-DU 174A, the CU 172 ensures that the UE 102 receives instructions in time from the CN 110 to setup, modify, or release resources or NAS configurations via the NAS message.

During or after performing 816 the random access procedure, the UE 102 sends 818 a RRC reconfiguration complete message to the C-DU 174B, via the candidate cell 126, which in turn forwards 819 the RRC reconfiguration complete message to the CU 172, similar to events 618 and 619, respectively. After performing 816 the random access procedure or transmitting 818 the RRC reconfiguration complete message, the UE 102 communicates 820 with the C-DU 174B and CU 172 by using the C-DU configuration, similar to 620.

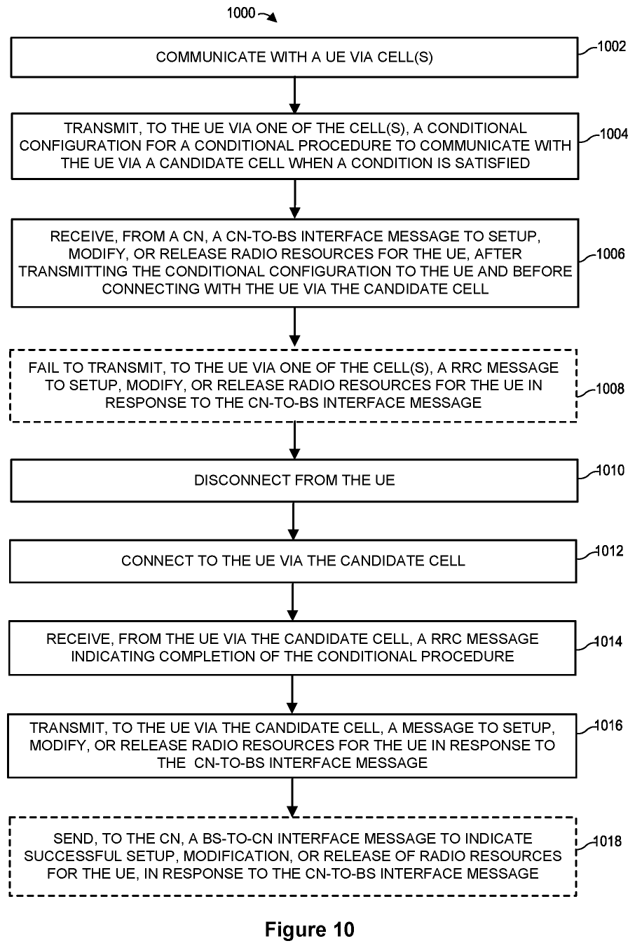

For further clarity, several example methods which the devices operating in the systems of FIGS. 1A and 1B can implement are discussed next with reference to FIGS. 9-15.

Referring first to FIG. 9, an example method 900 for configuring a UE with parameters to setup, modify, or release radio resources can be implemented in a suitable RAN, such as RAN 105 of FIG. 1A, as a set of instructions stored on a computer-readable medium and executable by processing hardware (e.g., one or more processors). For convenience, the method 900 is discussed below with reference to RAN 105, CN 110, and UE 102.

The method 900 begins at block 902, where the RAN 105 communicates with the UE 102 via cell(s) (e.g., in event 302).

At block 904, the RAN 105 transmits, to the UE 102 via one of the cell(s), a conditional configuration for a conditional procedure to communicate with the UE 102 via a candidate cell when a condition is satisfied (e.g., in event 308). In some implementations, the conditional configuration is a conditional handover configuration for a conditional handover procedure.

At block 906, after transmitting the conditional configuration to the UE 102 and before connecting with the UE 102 via the candidate cell, the RAN 105 receives, from the CN 110, a first CN-to-BS interface message to setup, modify, or release radio resources for the UE 102 (e.g., in event 322). In some implementations, the first CN-to-BS interface message can be a PDU session Resource message, such as a PDU Session Resource Setup Request message, a PDU Session Resource Modify Request message, or a PDU Session Resource Release Command message. In other implementations, the first CN-to-BS interface message can be a E-RAB message, such as a E-RAB Setup Request message, a E-RAB Modify Request message, or a E-RAB Release Command message. In yet other implementations, the first CN-to-BS interface message can be a NAS transport message that includes a NAS message.

At block 908, the RAN 105 disconnects from the UE 102 (e.g., in event 314). In some implementations, the RAN 105 disconnects from the UE 102 because the UE 102 determines that a condition associated with the conditional configuration is satisfied.

At block 910, the RAN 105 sends, to the CN 110, a first BS-to-CN interface message indicating failure to setup, modify, or release radio resources for the UE 102 in response to the first CN-to-BS interface message (e.g., in event 324). In some implementations, the first BS-to-CN interface message can be a PDU session Resource message, such as a PDU Session Resource Setup Response message, a PDU Session Resource Setup Failure message, a PDU Session Resource Modify Response message, a PDU Session Resource Modify Failure message, or a PDU Session Resource Release Response message. In other implementations, the first BS-to-CN interface message can be a E-RAB message, such as a E-RAB Setup Response message, a E-RAB Modify Response message, or a E-RAB Release Response message. In some implementations, the first BS-to-CN interface message can be an indication that the S-BS 104 failed to send, to the UE 102, a NAS message from the CN 110 to setup, modify, or release resources for the UE 102.

At block 912, the RAN 105 connects to the UE 102 via the candidate cell, in some implementations (e.g., in event 316).

At block 914, the RAN 105 receives, from the UE 102 via the candidate cell, an RRC message indicating completion of the conditional procedure, in some implementations (e.g., in event 318).

At block 916, after receiving the RRC message, the RAN 105 sends, to the CN 110, a second BS-to-CN interface message to establish a UE associated signaling connection between the UE 102 and the CN 110, in some implementations (e.g., in event 326). In some implementations, the second BS-to-CN interface message can be a Path Switch Request message.

At block 918, after sending the second BS-to-CN interface message, the RAN 105 receives, from the CN 110, a second CN-to-BS interface message to setup, modify, or release radio resources for the UE 102, in some implementations (e.g., in event 330). In some implementations, the second CN-to-BS interface message is the same as the first CN-to-BS interface message. In other implementations, the second CN-to-BS interface message is similar to the first CN-to-BS interface message with some differences.

At block 920, the RAN 105 transmits, to the UE 102 via the candidate cell, a message to setup, modify, or release radio resources for the UE in response to the second CN-to-BS interface message (e.g., in events 340, 342, 332). In some implementations, the message is an RRC message, such as an RRC reconfiguration message or an RRC release message. In other implementations, the message is a NAS message.

Now referring to FIG. 10, an example method 1000 for configuring a UE with parameters to setup, modify, or release radio resources can be implemented in a suitable distributed base station, such as distributed base station 104 of FIG. 1B, as a set of instructions stored on a computer-readable medium and executable by processing hardware (e.g., one or more processors). For convenience, the method 1000 is discussed below with reference to distributed base station 104, CN 110, and UE 102.

The method 1000 begins at block 1002, where the distributed base station 104 communicates with the UE 102 via cell(s) (e.g., in event 602), similar to block 902.

At block 1004, the distributed base station 104 transmits, to the UE 102 via one of the cell(s), a conditional configuration for a conditional procedure to communicate with the UE 102 via a candidate cell when a condition is satisfied (e.g., in events 607, 608), similar to block 904.

At block 1006, after transmitting the conditional configuration to the UE 102 and before connecting with the UE 102 via the candidate cell, the distributed base station 104 receives, from the CN 110, a CN-to-BS interface message to setup, modify, or release radio resources for the UE 102 (e.g., in event 622), similar to block 906.

At block 1008, the distributed base station 104 fails to transmit, to the UE 102 via one of the cell(s), an RRC message to setup, modify, or release radio resources for the UE 102 in response to the CN-to-BS interface message (e.g., in event 623), in some implementations. In some implementations, the RRC message is an RRC reconfiguration message.

At block 1010, the distributed base station 104 disconnects from the UE 102 (e.g., in event 614), similar to block 908.

At block 1012, the distributed base station 104 connects to the UE 102 via the candidate cell, similar to block 912 (e.g., in event 616).

At block 1014, the distributed base station 104 receives, from the UE 102 via the candidate cell, an RRC message indicating completion of the conditional procedure (e.g., in event 618), similar to block 914.

At block 1016, the distributed base station 104 transmits, to the UE 102 via the candidate cell, a message to setup, modify, or release radio resources for the UE 102 in response to the CN-to-BS interface message (e.g., in events 639, 640, 642, 643, 631, 632). In some implementations, the message is an RRC message, such as an RRC reconfiguration message or an RRC release message. In other implementations, the message is a NAS message.

At block 1018, the distributed base station 104 sends, to the CN 110, a BS-to-CN interface message to indicate successful setup, modification, or release of radio resources for the UE 102, in response to the CN-to-BS interface message, in some implementations (e.g., in events 636, 641).

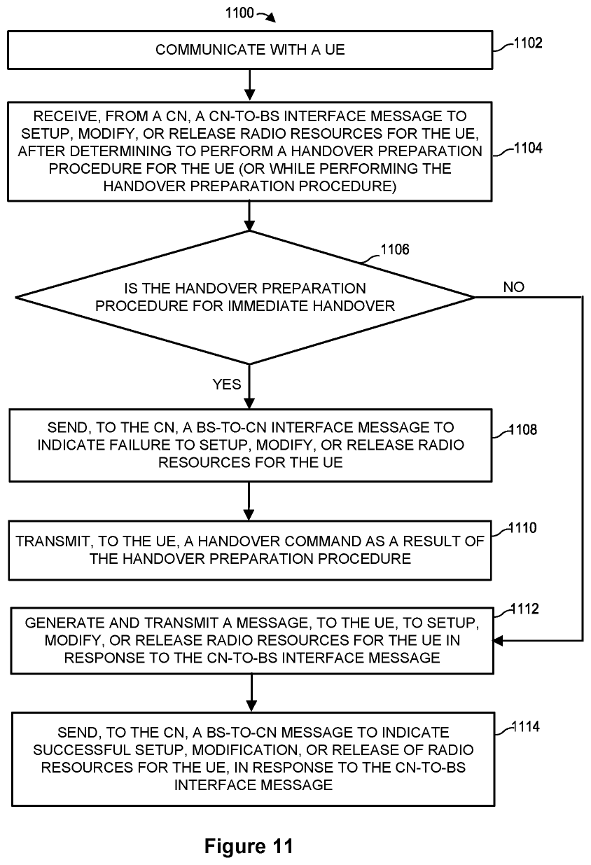

Now referring to FIG. 11, an example method 1100 for performing a handover preparation procedure in view of receiving a CN-to-BS interface message to setup, modify, or release radio resources after determining to perform the handover preparation procedure, or while performing the handover preparation procedure can be implemented in a suitable RAN, such as by a base station 104 of FIG. 1A or 1B operating in the RAN 105, as a set of instructions stored on a computer-readable medium and executable by processing hardware (e.g., one or more processors). For convenience, the method 1100 is discussed below with reference to RAN 105, CN 110, and UE 102.

The method 1100 begins at block 1102, where the RAN 105 communicates with the UE 102 via cell(s) (e.g., in events 302, 402, 602, 702).

At block 1104, the RAN 105 receives, from CN 110, a CN-to-BS interface message that requests the RAN 105 to setup, modify, or release radio resources for the UE 102 (e.g., in events 322, 422, 622, 722). In various implementations, the RAN 105 can receive the CN-to-BS interface message after determining to perform a handover preparation procedure, or while performing the handover preparation procedure.

If the RAN 105 at block 1106 determines to perform or is currently performing a handover preparation procedure that is for immediate handover (i.e., an immediate handover preparation procedure), the RAN 105 at block 1108 sends, to the CN 110, a BS-to-CN interface message to indicate failure to setup, modify, or release radio resources for the UE 102. In other words, the RAN 105 prioritizes the immediate handover preparation procedure over the request from the CN 110 to setup, modify, or release radio resources for the UE 102. Subsequently, the RAN 105 at block 1110 transmits, to the UE 102, an (immediate) handover command as a result of the immediate handover preparation procedure.

If the RAN 105 at block 1106 determines to perform or is currently performing a handover preparation procedure that is not for immediate handover (e.g., a conditional handover preparation procedure), the RAN 105 at block 1112 generates and transmits a message, to the UE 102, to setup, modify, or release radio resources for the UE 102 in response to the CN-to-BS interface message (e.g., in events 332, 340, 342, 440, 432, 631, 632, 639, 640, 642, 643, 739, 740). In other words, the RAN 105 prioritizes the request from the CN 110 to setup, modify, or release radio resources for the UE 102 over the conditional handover preparation procedure. In some various implementations, the message can be an RRC message or a NAS message. Subsequently, the RAN 105 at block 1114 can send, to the CN 110, a BS-to-CN interface message to indicate that the RAN 105 has successfully setup, modified, or released radio resources for the UE 102, in response to the CN-to-BS interface message received at block 1104 (e.g., in events 336, 341, 424, 636, 641, 724).

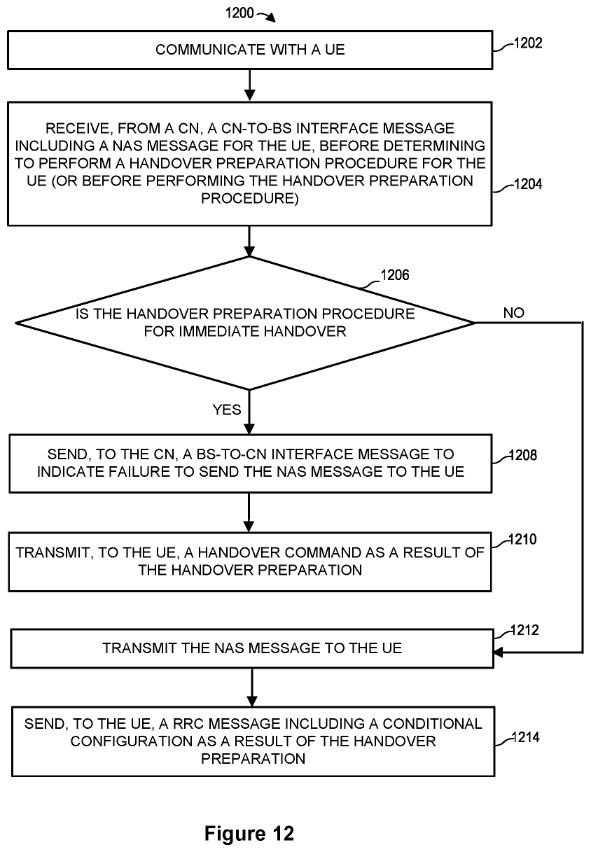

Now referring to FIG. 12, whereas the example method 1100 of FIG. 11 includes receiving a CN-to-BS interface message to setup, modify, or release radio resources for the UE 102 after determining to perform a handover preparation procedure, or while performing the handover preparation procedure, the example method 1200 of FIG. 12 includes receiving the CN-to-BS interface message before determining to perform the handover preparation procedure.

The method 1200 begins at block 1202, where the RAN 105 communicates with the UE 102 via cell(s) (e.g., in event 502), similar to block 1102.

At block 1204, the RAN 105 receives, from CN 110, a CN-to-BS interface message including a NAS message for the UE 102 (e.g., in events 506, 806). In various implementations, the RAN 105 can receive the CN-to-BS interface message before determining to perform a handover preparation procedure, or before performing the handover preparation procedure.

If the RAN 105 at block 1206 determines to perform a handover preparation procedure that is for immediate handover (i.e., an immediate handover preparation procedure), the RAN 105 at block 1208 sends, to the CN 110, a BS-to-CN interface message to indicate failure to send the NAS message to the UE 102. In other words, the RAN 105 prioritizes the immediate handover preparation procedure over the request from the CN 110 to setup, modify, or release radio resources for the UE 102. Subsequently, the RAN 105 at block 1210 transmits, to the UE 102, an (immediate) handover command as a result of the immediate handover preparation procedure, similar to block 1110.

If the RAN 105 at block 1206 determines to perform a handover preparation procedure that is not for immediate handover (e.g., a conditional handover preparation procedure), the RAN 105 at block 1212 transmits (e.g., forwards) the NAS message, to the UE 102, to setup, modify, or release resources for the UE 102 (e.g., in events 544, 844). In other words, the RAN 105 prioritizes the request from the CN 110 to setup, modify, or release resources for the UE 102 over the conditional handover preparation procedure. Subsequently, the RAN 105 at block 1214 can send, to the UE 102, an RRC message including a conditional configuration as a result of the conditional handover preparation procedure (e.g., in events 508, 808).

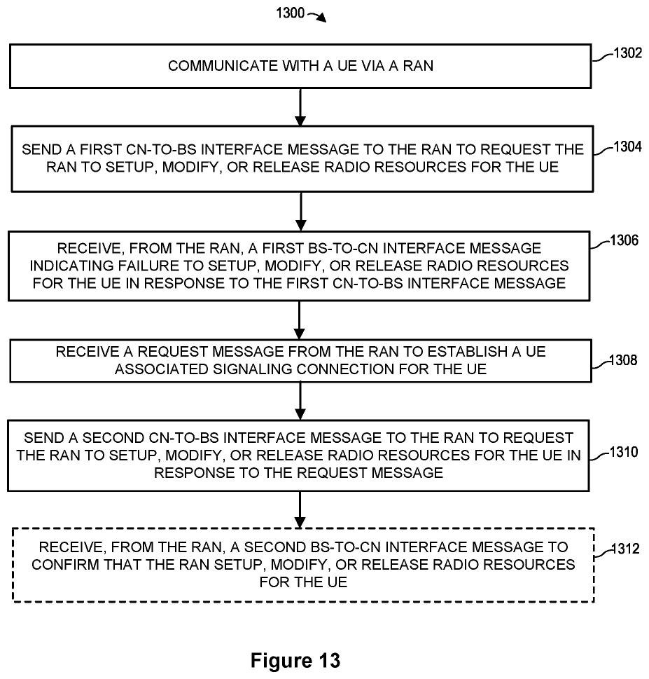

Now referring to FIG. 13, an example method 1300 for sending a follow-up message to a RAN to setup, modify, or release radio resources for a UE in response to receiving from the RAN an indication of previously failing to setup, modify, or release the radio resources can be implemented in a suitable CN, such as CN 110 of FIG. 1A, as a set of instructions stored on a computer-readable medium and executable by processing hardware (e.g., one or more processors). For convenience, the method 1300 is discussed below with reference to CN 110, RAN 105, and UE 102.

The method 1300 begins at block 1302, where the CN 110 communicates with the UE 102 via the RAN 105 (e.g., in event 302).

At block 1304, the CN 110 sends a first CN-to-BS interface message to the RAN 105 to request the RAN 105 to setup, modify, or release radio resources for the UE 102 (e.g., in event 322), similar to block 906.

At block 1306, the CN 110 receives, from the RAN 105, a first BS-to-CN interface message indicating failure to setup, modify, or release radio resources for the UE 102 in response to the first CN-to-BS interface message (e.g., in event 324), similar to block 910.

At block 1308, the CN 110 receives a request message from the RAN 105 to establish a UE associated signaling connection for the UE 102 (e.g., in event 326), similar to block 916.

At block 1310, the CN 110 sends a second CN-to-BS interface message to the RAN 105 to request the RAN 105 to setup, modify, or release radio resources for the UE 102 in response to the request message (e.g., in event 330), similar to block 918.

At block 1312, the CN 110 in some implementations receives, from the RAN, a second BS-to-CN interface message to confirm that the RAN 105 has successfully setup, modified, or released radio resources for the UE 102 (e.g., in events 336, 341), similar to block 1114.

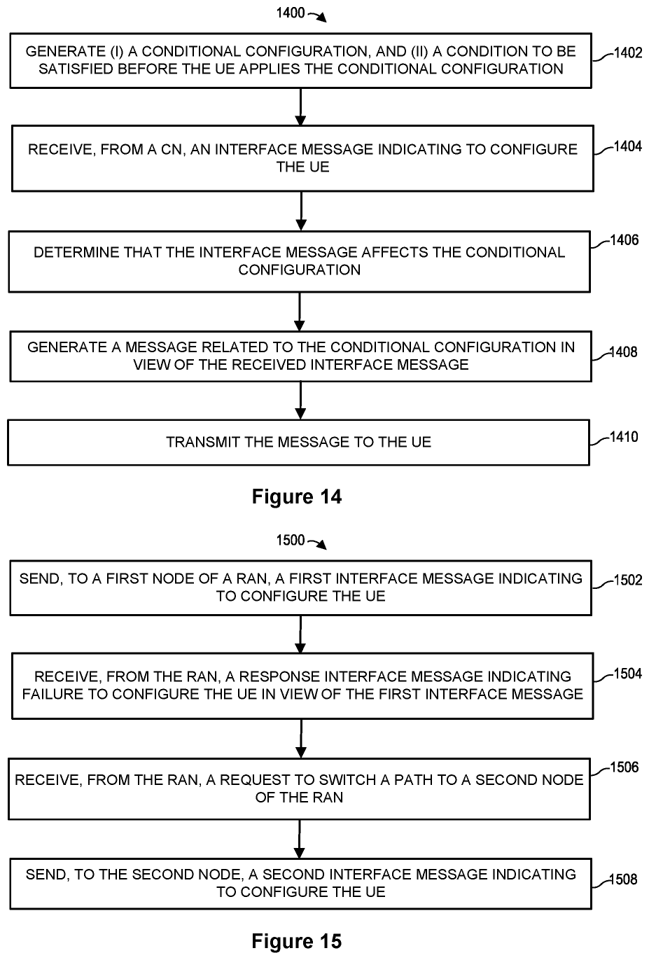

Now referring to FIG. 14, an example method 1400 for configuring a UE can be implemented in a suitable RAN, such as RAN 105 of FIG. 1A, as a set of instructions stored on a computer-readable medium and executable by processing hardware (e.g., one or more processors). For convenience, the method 1400 is discussed below with reference to RAN 105, CN 110, and UE 102.

The method 1400 begins at block 1402, where the RAN 105 generates a conditional configuration, and a condition to be satisfied before the UE 102 applies the conditional configuration (e.g., in events 306, 406, 506, 606, 706, 806). In some implementations, the conditional configuration is a conditional handover configuration for the UE 102 to hand over from a source base station (e.g., S-BS 104) to a candidate base station (e.g., C-BS 106). In other implementations, the conditional configuration is a conditional handover configuration for the UE 102 to hand over from a source DU (e.g., S-DU 174A) to a candidate DU (e.g., C-DU 174B).

At block 1404, the RAN 105 receives, from the CN 110, an interface message indicating to configure the UE 102, similar to block 906 (e.g., in events 322, 422, 423, 542, 622, 722, 723, 842).

At block 1406, the RAN 105 determines that the interface message affects the conditional configuration. In some implementations, the RAN 105 determines that the interface message affects the conditional configuration because a node included in the RAN 105 would not be able to deliver the interface message to the UE 102 as a result of the UE 102 having disconnected from the node pursuant to the conditional configuration (e.g., in events 314, 614). In other implementations, the RAN 105 determines that the conditional configuration does not contain configuration parameters to configure the UE 102 in accordance with the interface message, when the RAN 105 receives the interface message after already having generated the conditional configuration (e.g., in events 422, 406, 722, 706, 542, 506, 842, 806). In yet other implementations, the RAN 105 determines that the conditional configuration contains configuration parameters to configure the UE 102 in accordance with the interface message, when the RAN 105 receives the interface message before generating the conditional configuration and considers the interface message when generating the conditional configuration (e.g., in events 423, 723).

At block 1408, the RAN 105 generates a message related to the conditional configuration in view of the received interface message. In some implementations, as a result of the UE 102 having disconnected from a first node of the RAN 105 and connected to a second node of the RAN 105 pursuant to the conditional configuration, the second node generates a message in view of the received interface message (e.g., in events 340, 342, 332, 640, 643, 632). In other implementations, as a result of the RAN 105 determining that the conditional configuration does not contain configuration parameters to configure the UE 102 in accordance with the interface message, the RAN 105 generates a message in view of the received interface message (e.g., in events 440, 432, 740, 732, 544, 844). In yet other implementations, as a result of the RAN 105 determining that the conditional configuration contains configuration parameters to configure the UE 102 in accordance with the interface message, the RAN 105 generates a message in view of the received interface message (e.g., in events 433, 733).

At block 1410, the RAN 105 transmits the message to the UE 102, similar to block 920 (e.g., in events 340, 342, 332, 440, 432, 433, 544, 640, 643, 632, 740, 732, 733, 844).

Now referring to FIG. 15, an example method 1500 for configuring a UE can be implemented in a suitable CN, such as CN 110 of FIG. 1A, as a set of instructions stored on a computer-readable medium and executable by processing hardware (e.g., one or more processors). For convenience, the method 1500 is discussed below with reference to CN 110, RAN 105, and UE 102.

The method 1500 begins at block 1502, where the CN 110 sends, to a first node of the RAN 105, a first interface message indicating to configure the UE 102 (e.g., in event 322), similar to block 1304.

At block 1504, the CN 110 receives, from the RAN 105, a response interface message indicating failure to configure the UE in view of the first interface message (e.g., in event 324), similar to block 1306.

At block 1506, the CN 110 receives, from the RAN 105, a request to switch a path to a second node of the RAN 105 (e.g., in event 326), similar to block 1308.

At block 1508, the CN 110 sends, to the second node, a second interface message indicating to configure the UE 102 (e.g., in event 330), similar to block 1310.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters included in the MN or SN configuration described above. For example, “configuration” can be replaced by “configurations” or “configuration parameters”. The MN configuration or SN configuration can be replaced by a cell group configuration and/or radio bearer configuration.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for managing configurations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

Example 1. A method in a radio access network (RAN) for configuring a user equipment (UE), the method comprising: generating, by processing hardware, (i) a conditional configuration, and (ii) a condition to be satisfied before the UE applies the conditional configuration; receiving, by the processing hardware and from a core network (CN), an interface message indicating to configure the UE; determining, by the processing hardware, that the interface message affects the conditional configuration; generating, by the processing hardware, a message related to the conditional configuration in view of the received interface message; and transmitting, by the processing hardware, the message to the UE.

Example 2. The method of example 1, further comprising, before receiving the interface message from the CN: transmitting, by a first node of the RAN, the conditional configuration to the UE.

Example 3. The method of example 2, further comprising: determining that a radio connection between the UE and the first node is suspended, wherein transmitting the message to the UE includes transmitting the message via a second node of the RAN, after the UE connects to the second node.

Example 4. The method of example 3, wherein the interface message is a first interface message, the method further comprising: in response to determining that the radio connection is suspended, sending, by the first node and to the CN, an indication of failing to setup, modify, or release a resource; and receiving, by the second node and from the CN, a second interface message to setup, modify, or release the resource.

Example 5. The method of example 4, wherein transmitting the message to the UE includes transmitting, by the second node, the message to the UE in response to receiving the second interface message.

Example 6. The method of example 3, wherein: receiving the interface message includes receiving, by the first node, the interface message; and transmitting the message to the UE includes transmitting, by the first node, the message to the UE via the second node in response to receiving the interface message.

Example 7. The method of example 1, wherein generating the conditional configuration includes generating, by a second node of the RAN, the conditional configuration, the method further comprising: determining, by a first node of the RAN, that the conditional configuration omits one or more parameters to setup, modify, or release a resource; and preventing, by the first node, transmission of the conditional configuration to the UE.

Example 8. The method of example 1, wherein generating the conditional configuration includes generating, by a second node of the RAN, the conditional configuration, the method further comprising: determining, by a first node of the RAN, that the conditional configuration includes one or more parameters to setup, modify, or release a resource; and transmitting, by the first node of the RAN, the conditional configuration to the UE.

Example 9. The method of any one of examples 1-8, where the message is a first message, the method further comprising: after transmitting the first message to the UE, sending a second message to the CN to indicate that the RAN has configured the UE.

Example 10. The method of example 1, wherein generating the conditional configuration includes generating, by a second node of the RAN, the conditional configuration, the method further comprising: transmitting, by a first node of the RAN, the conditional configuration to the UE subsequent to transmitting the message.

Example 11. The method of example 10, wherein: the interface message includes a non-access stratum (NAS) message, and the message includes the NAS message.

Example 12. The method of any one of examples 2-5 and 7-11, wherein: the first node is a source base station (S-BS) included in the RAN, and the second node is a candidate base station (C-BS) included in the RAN.

Example 13. The method of any one of examples 2-3 and 9-11, wherein: the first node is a source distributed unit (S-DU) in a distributed base station included in the RAN, and the second node is a candidate DU (C-DU) in the distributed base station.

Example 14. The method of any one of examples 6-8, wherein: the first node is a central unit (CU) in a distributed base station included in the RAN, and the second node is a C-DU included in the distributed base station.

Example 15. The method of any of the preceding examples, wherein the conditional configuration is for a conditional handover (CHO) procedure.

Example 16. The method of any of the preceding examples, wherein the generating occurs in a first instance; the method further comprising, in a second instance: generating an immediate configuration for an immediate handover procedure; and sending, to the CN, a response interface message to indicate that the RAN failed to configure the UE.

Example 17. One or more base stations comprising processing hardware and configured to implement a method of any of the preceding examples.

Example 18. A method in a core network (CN) for configuring a user equipment (UE), the method comprising: sending, by processing hardware and to a first node of a radio access network (RAN), a first interface message indicating to configure the UE; receiving, by the processing hardware and from the RAN, a response interface message indicating failure to configure the UE in view of the first interface message; receiving, by the processing hardware and from the RAN, a request to switch a path to a second node of the RAN; and sending, by the processing hardware and to the second node, a second interface message indicating to configure the UE.

Example 19. The method of example 18, wherein the request further includes an indication to establish a connection between the UE and the CN.

Example 20. The method of example 18 or 19, wherein the response interface message is a first response interface message, the method further comprising: receiving, by the processing hardware and from the RAN, a second response interface message to indicate that the RAN has configured the UE.

Example 21. The method of any one of examples 18-20, wherein: receiving the response interface message includes receiving, from the first node, an indication of failing to setup, modify, or release a resource; and sending the second interface message includes sending, to the second node, an indication to setup, modify, or release the resource.

Example 22. The method any one of examples 18-21, wherein: the first node is a source base station (S-BS) included in the RAN, and the second node is a candidate base station (C-BS) included in the RAN.

Example 23. A CN comprising processing hardware and configured to implement a method of any one of examples 18-22.

What is claimed is:

1. A method in a radio access network (RAN) for configuring a user equipment (UE), the method comprising:
generating, by processing hardware, (i) a conditional configuration, and (ii) a condition to be satisfied before the UE applies the conditional configuration;
receiving, by the processing hardware and from a core network (CN), an interface message indicating to configure the UE;
determining, by the processing hardware, that the interface message affects the conditional configuration;
generating, by the processing hardware, a message related to the conditional configuration in view of the received interface message; and
transmitting, by the processing hardware, the message to the UE.

2. The method of claim 1, further comprising, before receiving the interface message from the CN:
transmitting, by a first node of the RAN, the conditional configuration to the UE.

3. The method of claim 2, further comprising:
determining that a radio connection between the UE and the first node is suspended,
wherein transmitting the message to the UE includes transmitting the message via a second node of the RAN, after the UE connects to the second node.

4. The method of claim 1, wherein generating the conditional configuration includes generating, by a second node of the RAN, the conditional configuration, the method further comprising:
determining, by a first node of the RAN, that the conditional configuration omits one or more parameters to setup, modify, or release a resource; and
preventing, by the first node, transmission of the conditional configuration to the UE.

5. The method of claim 1, wherein generating the conditional configuration includes generating, by a second node of the RAN, the conditional configuration, the method further comprising:
determining, by a first node of the RAN, that the conditional configuration includes one or more parameters to setup, modify, or release a resource; and
transmitting, by the first node of the RAN, the conditional configuration to the UE.

6. The method of claim 1, wherein generating the conditional configuration includes generating, by a second node of the RAN, the conditional configuration, the method further comprising:
transmitting, by a first node of the RAN, the conditional configuration to the UE subsequent to transmitting the message.

7. The method of any of the preceding claims, wherein the conditional configuration is for a conditional handover (CHO) procedure.

8. The method of any of the preceding claims, wherein the generating occurs in a first instance; the method further comprising, in a second instance:
generating an immediate configuration for an immediate handover procedure; and
sending, to the CN, a response interface message to indicate that the RAN failed to configure the UE.

9. One or more base stations comprising processing hardware and configured to implement a method of any of the preceding claims.

10. A method in a core network (CN) for configuring a user equipment (UE), the method comprising:
sending, by processing hardware and to a first node of a radio access network (RAN), a first interface message indicating to configure the UE;
receiving, by the processing hardware and from the RAN, a response interface message indicating failure to configure the UE in view of the first interface message;
receiving, by the processing hardware and from the RAN, a request to switch a path to a second node of the RAN; and
sending, by the processing hardware and to the second node, a second interface message indicating to configure the UE.

11. The method of claim 10, wherein the request further includes an indication to establish a connection between the UE and the CN.

12. The method of claim 10 or 11, wherein the response interface message is a first response interface message, the method further comprising:
receiving, by the processing hardware and from the RAN, a second response interface message to indicate that the RAN has configured the UE.

13. The method of any one of claims 10-12, wherein:
receiving the response interface message includes receiving, from the first node, an indication of failing to setup, modify, or release a resource; and
sending the second interface message includes sending, to the second node, an indication to setup, modify, or release the resource.

14. The method any one of claims 10-13, wherein:
the first node is a source base station (S-BS) included in the RAN, and
the second node is a candidate base station (C-BS) included in the RAN.

15. A CN comprising processing hardware and configured to implement a method of any one of claims 10-14.
